(19) United States
(12) Patent Application Publication
(10) Pub. No.: US 2025/0285817 A1
(43) Pub. Date: Sep. 11, 2025

(54) Ultracapacitor for Use in a Solder Reflow Process

(71) Applicant: KYOCERA AVX Components Corporation, Fountain Inn, SC (US)

(72) Inventors: Michael J. Maich, Simpsonville, SC (US); Xiaorong Liu, Simpsonville, SC (US); Laurent Desclos, San Diego, CA (US); Kenneth Griffith, Simpsonville, SC (US)

(21) Appl. No.: 19/070,787

(22) Filed: Mar. 5, 2025

Related U.S. Application Data
(60) Provisional application No. 63/561,791, filed on Mar. 6, 2024.

(51) Int. Cl. H01G 11/82; H01G 11/34; H01G 11/48; H01G 11/60

(52) U.S. Cl. CPC H01G 11/82; H01G 11/34; H01G 11/48; H01G 11/60

(57) ABSTRACT

An ultracapacitor is disclosed. The ultracapacitor comprises a package, a first conductive member and a second conductive member, an electrode assembly, and an electrolyte. The package comprises: a base having an inner base surface and an outer base surface opposite the inner base surface; sidewalls extending in a direction generally perpendicular to the base and defining a first upper end and a first sidewall inner surface, an interior cavity defined between the inner base surface and the first sidewall inner surface; a lid enclosing the interior cavity; and wherein the base and the sidewalls are formed from a liquid crystalline polymer. The first conductive member and the second conductive member are disposed in the interior cavity and extend from the base. The electrode assembly is positioned within the interior cavity of the package. The electrode assembly comprises a first electrode and a second electrode electrically connected to a first lead and a second lead, respectively, extending from the electrode assembly wherein the first lead and the second lead are electrically connected to the first conductive member and the second conductive member, respectively. The electrolyte is provided within the interior cavity of the package. The present disclosure also discloses a circuit board including the aforementioned ultracapacitor as well as a communications device including the aforementioned ultracapacitor.

### BACKGROUND OF THE DISCLOSURE

Electrical energy storage cells are widely used to provide power to electronic, electromechanical, electrochemical, and other useful devices. An electric double layer ultracapacitor, for instance, generally employs a pair of polarizable electrodes that contain carbon particles (e.g., activated carbon) impregnated with a liquid electrolyte. Due to the effective surface area of the particles and the small spacing between the electrodes, large capacitance values may be achieved. Nevertheless, problems remain. For instance, it is often desirable to attach ultracapacitors to a circuit board using a “solder reflow” process during which a solder paste is used to temporarily attach the ultracapacitor and then heated to a relatively high peak temperature (e.g., about 150° C. or more, such as about 200° C. or more or even about 240° C. or more) to melt the solder paste and connect the capacitor to the board. Unfortunately, however, most conventional ultracapacitors are highly sensitive to temperature and thus cannot be readily employed in solder reflow processes.

As such, a need currently exists for an improved ultracapacitor that can operate at high temperatures and still maintain stable electrochemical properties.

### SUMMARY OF THE DISCLOSURE

In accordance with one embodiment of the present disclosure, an ultracapacitor is disclosed. The ultracapacitor comprises a package, a first conductive member and a second conductive member, an electrode assembly, and an electrolyte. The package comprises: a base having an inner base surface and an outer base surface opposite the inner base surface; sidewalls extending in a direction generally perpendicular to the base and defining a first upper end and a first sidewall inner surface, an interior cavity defined between the inner base surface and the first sidewall inner surface; a lid enclosing the interior cavity; and wherein the base and the sidewalls are formed from a liquid crystalline polymer. The first conductive member and the second conductive member are disposed in the interior cavity and extend from the base. The electrode assembly is positioned within the interior cavity of the package. The electrode assembly comprises a first electrode and a second electrode electrically connected to a first lead and a second lead, respectively, extending from the electrode assembly wherein the first lead and the second lead are electrically connected to the first conductive member and the second conductive member, respectively. The electrolyte is provided within the interior cavity of the package.

In accordance with another embodiment of the present disclosure, a circuit board is disclosed. The circuit board includes the aforementioned ultracapacitor.

In accordance with another embodiment of the present disclosure, a communications device is disclosed. The communications device includes the aforementioned ultracapacitor.

In accordance with another embodiment of the present disclosure, an ultracapacitor is disclosed. The ultracapacitor comprises a package, a first conductive member and a second conductive member, an electrode assembly, and an electrolyte. The package comprises: a base having an inner base surface and an outer base surface opposite the inner base surface; sidewalls extending in a direction generally perpendicular to the base and defining a first upper end, a second upper end, a first sidewall inner surface, and a second sidewall inner surface, and an interior cavity defined between the inner base surface and the first sidewall inner surface, wherein the first upper end and the first sidewall inner surface are positioned closer to the interior cavity than the second upper end and the second sidewall inner surface. The first conductive member and the second conductive member are disposed in the interior cavity and extend from the base. The electrode assembly is positioned within the interior cavity of the package. The electrode assembly comprises a first electrode and a second electrode electrically connected to a first lead and a second lead, respectively, extending from the electrode assembly wherein the first lead and the second lead are electrically connected to the first conductive member and the second conductive member, respectively. The electrolyte is provided within the interior cavity of the package.

In accordance with another embodiment of the present disclosure, a circuit board is disclosed. The circuit board includes the aforementioned ultracapacitor.

In accordance with another embodiment of the present disclosure, a communications device is disclosed. The communications device includes the aforementioned ultracapacitor.

Other features and aspects of the present disclosure are set forth in greater detail below.

### BRIEF DESCRIPTION OF THE DRAWINGS

A full and enabling disclosure of the present disclosure, including the best mode thereof, directed to one of ordinary skill in the art, is set forth more particularly in the remainder of the specification, which makes reference to the appended figure in which:

FIGS. 1A-1C illustrate one embodiment of a package according to the present disclosure;

FIGS. 2A-2D illustrate embodiments of an ultracapacitor with different package/lid designs according to the present disclosure;

FIGS. 2E-2J illustrate embodiments of package, including a lid, a base, and sidewalls, which may be utilized in forming an ultracapacitor with different package/lid designs according to the present disclosure;

FIG. 3 illustrates one embodiment for forming an electrode assembly that can be used in the ultracapacitor of the present disclosure.

FIG. 4 illustrates one embodiment of a current collector that may be employed in the ultracapacitor of the present disclosure;

FIG. 5 illustrates one embodiment of a current collector/carbonaceous coating configuration that may be employed in the ultracapacitor of the present disclosure; and

Repeat use of reference characters in the present specification and drawing is intended to represent same or analogous features or elements of the disclosure.

### DETAILED DESCRIPTION OF REPRESENTATIVE EMBODIMENTS

It is to be understood by one of ordinary skill in the art that the present discussion is a description of exemplary embodiments only and is not intended as limiting the broader aspects of the present disclosure, which broader aspects are embodied in the exemplary construction.

Generally speaking, the present disclosure is directed to an ultracapacitor. The ultracapacitor includes an electrode assembly, an electrolyte, and a package for housing the electrode assembly and the electrolyte. The present inventors have discovered that various benefits may be realized by providing an ultracapacitor, and particularly a package, as described herein. For instance, by providing the ultracapacitor having a package disclosed, the ultracapacitor may be mounted onto a circuit board, such as a printed circuit board, in a more efficient and less costly manner. For example, instead of having to electrically and/or physically connect the leads of an ultracapacitor to the circuit board, the conductive members/terminations utilized with the package of the ultracapacitor as disclosed herein may be electrically and/or physically connected to the circuit board using means generally known in the art. In turn, any potential issues with the performance and/or structural integrity of the ultracapacitor may also be avoided thereby improving the service life and the strength of the ultracapacitor.

Various embodiments of the present disclosure will now be described in more detail.

### Ultracapacitor

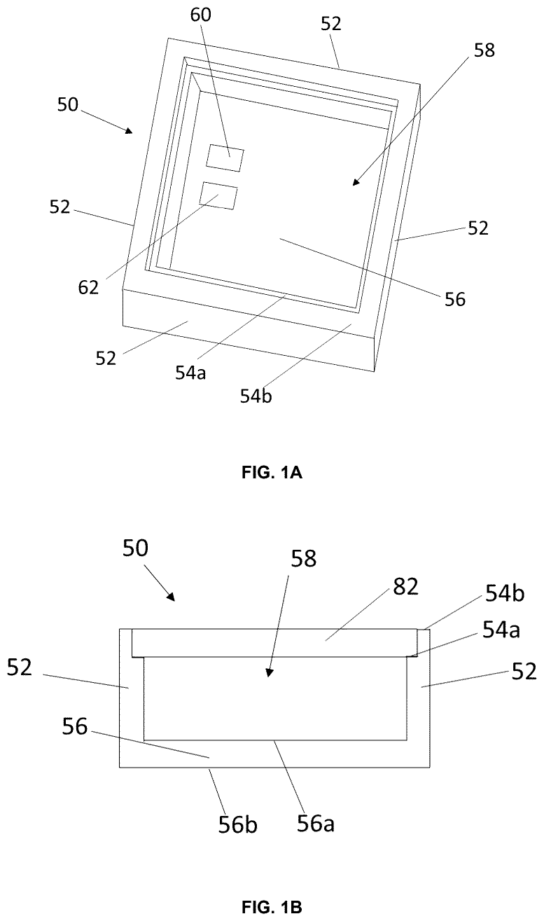

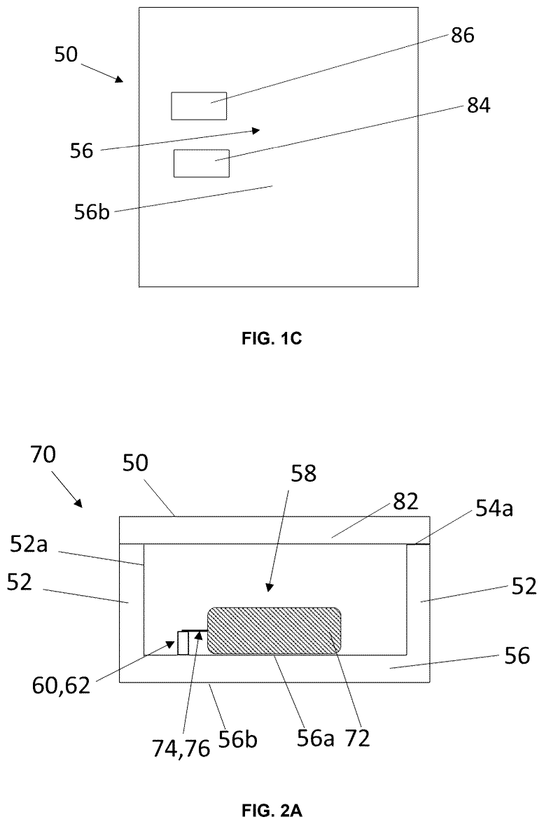

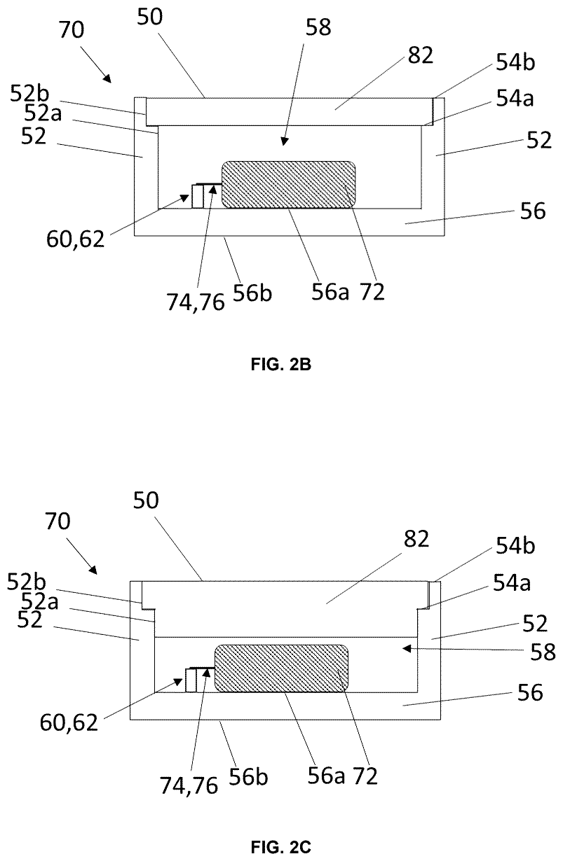

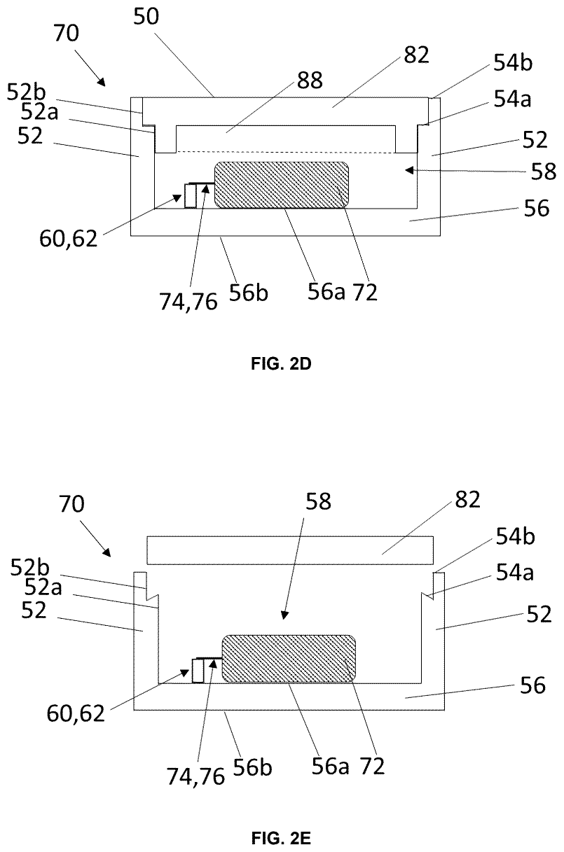

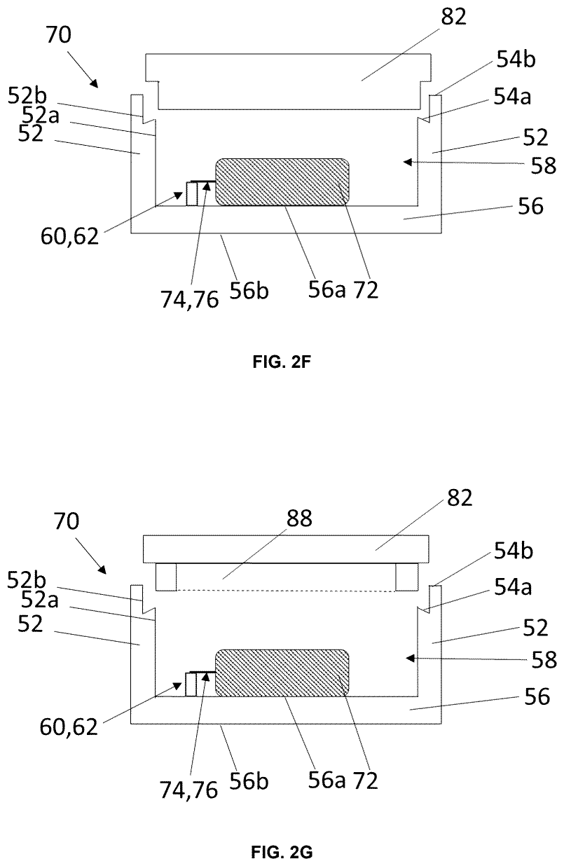

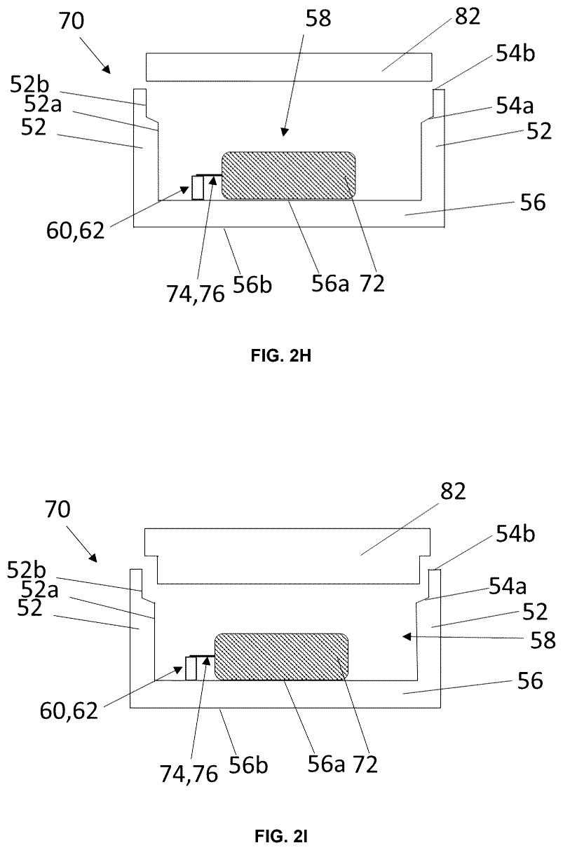

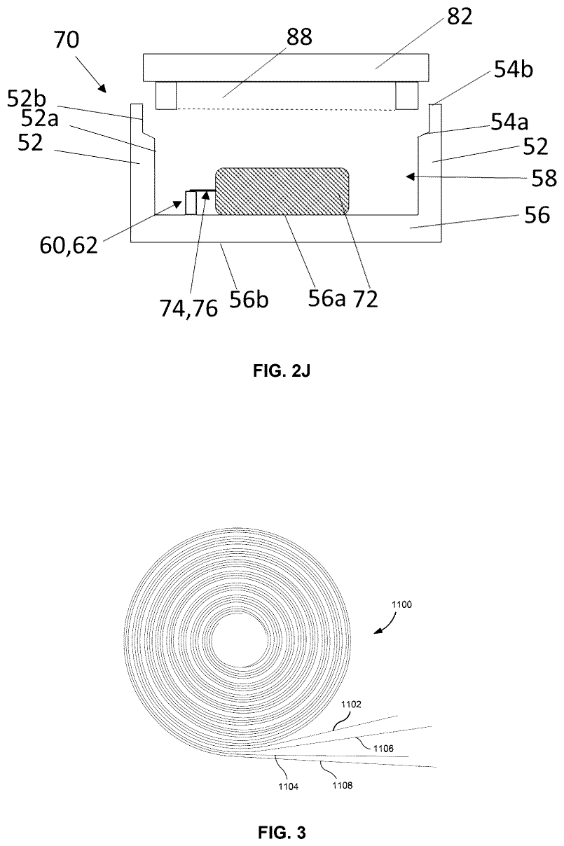

As indicated herein, the present disclosure is directed to an ultracapacitor. Referring to FIGS. 1A-1C and 2A-2J, various embodiments of such an ultracapacitor as well as corresponding package designs are illustrated. In particular, the ultracapacitor 70 includes a package 50 for housing an electrode assembly 72 within an interior cavity 58 of the package 50. In addition, the package 50 houses an electrolyte (not shown) within the interior cavity 58 of the package 50. In this regard, the electrode assembly 72 and electrolyte are sealed and retained within the package 50.

### Electrode Assembly

In general, as indicated above, the ultracapacitor contains an electrode assembly including a first electrode, a second electrode, and a separator. For instance, the first electrode typically includes a first electrode containing a first carbonaceous coating (e.g., activated carbon particles) electrically coupled to a first current collector, and a second electrode typically includes a second carbonaceous coating (e.g., activated carbon particles) electrically coupled to a second current collector. A separator may also be positioned between the first electrode and the second electrode.

In forming the electrode assembly, the electrodes and separator may be initially folded, wound, or otherwise contacted together to form an electrode assembly. The electrolyte may optionally be immersed into the electrodes of the assembly. In one particular embodiment, the electrodes, separator, and optional electrolyte may be wound into an electrode assembly having a “jelly-roll” configuration. Referring to FIG. 3, for instance, one embodiment of such a jellyroll electrode assembly 1100 is shown that contains a first electrode 1102, a second electrode 1104, and a separator 1106 positioned between the electrodes 1102 and 1104. In this particular embodiment, the electrode assembly 1100 also includes another separator 1108 that is positioned over the second electrode 1104. In this manner, each of two coated surfaces of the electrodes is separated by a separator, thereby maximizing surface area per unit volume and capacitance. While by no means required, the electrodes 1102 and 1104 are offset in this embodiment so as to leave their respective contact edges extending beyond first and second edges of the first and second separators 1106 and 1108, respectively. Among other things, this can help prevent “shorting” due to the flow of electrical current between the electrodes. However, it should be understood that other configurations may also be utilized. For instance, in another embodiment, the electrodes, separator, and optional electrolyte may be provided as an electrode assembly having a laminar configuration.

The ultracapacitor also includes first and second leads electrically connected to the first and second electrodes, respectively, within the electrode assembly. For instance, in one embodiment, at least one lead may be provided on one end of the electrode assembly while a second lead may be provided on an opposing end of the electrode assembly. In this regard, the leads may extend from opposing ends of the electrode assembly. In another embodiment, both leads may be provided on the same end of the electrode assembly. In this regard, the leads may extend from the same end of the electrode assembly.

### Electrodes

As indicated above, the ultracapacitor includes an electrode assembly including a first electrode and a second electrode. The electrodes employed within the electrode assembly generally contain a current collector. The current collectors may be formed from the same or different materials. For instance, in one embodiment, the current collectors of each electrode are formed from the same material. Regardless, each collector is typically formed from a substrate that includes a conductive metal, such as aluminum, stainless steel, nickel, silver, palladium, etc., as well as alloys thereof. Aluminum and aluminum alloys are particularly suitable for use in the present disclosure.

The current collector substrate may be in the form of a foil, sheet, plate, mesh, etc. The substrate may also have a relatively small thickness, such as about 200 micrometers or less, such as about 150 micrometers or less, such as about 100 micrometers or less, such as about 80 micrometers or less, such as about 50 micrometers or less, such as about 40 micrometers or less, such as about 30 micrometers or less. The substrate may have a thickness of about 1 micrometer or more, such as about 5 micrometers or more, such as about 10 micrometers or more, such as about 20 micrometers or more.

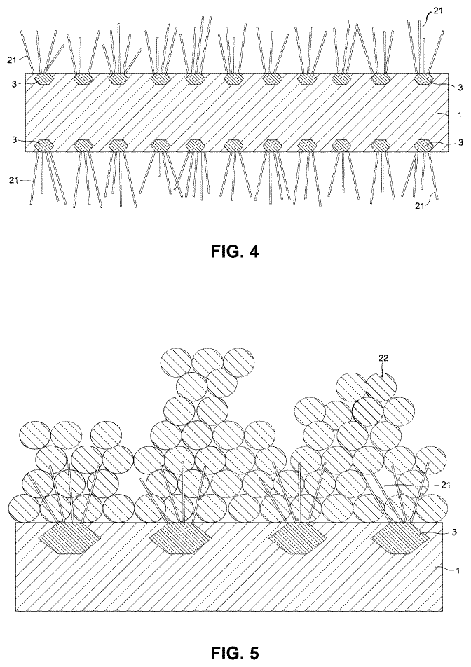

Although by no means required, the surface of the substrate may be treated. For example, in one embodiment, the surface may be roughened, such as by washing, etching, blasting, etc. In certain embodiments, the current collector may contain a plurality of fiber-like whiskers that project outwardly from the substrate. Without intending to be limited by theory, it is believed that these whiskers can effectively increase the surface area of the current collector and also improve the adhesion of the current collector to the corresponding electrode. This can allow for the use of a relatively low binder content in the first electrode and/or second electrode, which can improve charge transfer and reduce interfacial resistance and consequently result in very low ESR values. The whiskers are typically formed from a material that contains carbon and/or a reaction product of carbon and the conductive metal. If desired, the whiskers may optionally project from a seed portion that is embedded within the substrate. Similar to the whiskers, the seed portion may also be formed from a material that contains carbon and/or a reaction product of carbon and the conductive metal, such as a carbide of the conductive metal (e.g., aluminum carbide). Referring to FIG. 4, for instance, one embodiment of a current collector is shown that contains a plurality of whiskers 21 projecting outwardly from a substrate 1. If desired, the whiskers 21 may optionally project from a seed portion 3 that is embedded within the substrate 1. Similar to the whiskers 21, the seed portion 3 may also be formed from a material that contains carbon and/or a reaction product of carbon and the conductive metal, such as a carbide of the conductive metal (e.g., aluminum carbide). Further, FIG. 5 illustrates an electrode including the aforementioned current collector having a plurality of whiskers 21 projecting outwardly from a substrate 1 in combination with a carbonaceous coating 22 as described herein.

The manner in which such whiskers are formed on the substrate may vary as desired. In one embodiment, for instance, the conductive metal of the substrate is reacted with a hydrocarbon compound. Examples of such hydrocarbon compounds may include, for instance, paraffin hydrocarbon compounds, such as methane, ethane, propane, n-butane, isobutane, pentane, etc.; olefin hydrocarbon compounds, such as ethylene, propylene, butene, butadiene, etc.; acetylene hydrocarbon compounds, such as acetylene; as well as derivatives or combinations of any of the foregoing. It is generally desired that the hydrocarbon compounds are in a gaseous form during the reaction. Thus, it may be desired to employ hydrocarbon compounds, such as methane, ethane, and propane, which are in a gaseous form when heated. Although not necessarily required, the hydrocarbon compounds are typically employed in a range of from about 0.1 parts to about 50 parts by weight, and in some embodiments, from about 0.5 parts by weight to about 30 parts by weight, based on 100 parts by weight of the substrate. To initiate the reaction with the hydrocarbon and conductive metal, the substrate is generally heated in an atmosphere that is at a temperature of about 300° C. or more, in some embodiments about 400° C. or more, and in some embodiments, from about 500° C. to about 650° C. The time of heating depends on the exact temperature selected, but typically ranges from about 1 hour to about 100 hours. The atmosphere typically contains a relatively low amount of oxygen to minimize the formation of a dielectric film on the surface of the substrate. For example, the oxygen content of the atmosphere may be about 1% by volume or less.

The substrate may also be treated with a conductive coating in one embodiment. For instance, without intending to be limited, the conductive coating may be utilized to reduce contact resistance between the substrate of the current collector and the carbonaceous coating. In this regard, the conductive coating may include a conductive material comprising graphite, graphene, and/or carbon black. The conductive material may be present in the conductive coating in an amount of 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more, such as 97 wt. % or more, such as 98 wt. % or more, such as 99 wt. % or more. The conductive coating may be provided only on one major surface of the substate in one embodiment. In another embodiment, the conductive coating may be provided on both major surfaces of the substrate. The conductive coating may have a thickness of 0.1 microns or more, such as 0.2 microns or more, such as 0.3 microns or more, such as 0.5 microns or more, such as 1 microns or more, such as 1.5 microns or more, such as 2 microns or more, such as 2.5 microns to 5 microns or less, such as 4 microns or less, such as 3 microns or less, such as 2.5 microns or less, such as 2 microns or less, such as 1.5 microns or less.

The electrodes used in the ultracapacitor also contain carbonaceous coatings or carbonaceous materials that are coated onto opposing sides of the current collectors. While they may be formed from the same or different types of materials and may contain one or multiple layers, each of the carbonaceous coatings generally contains at least one layer that includes activated particles. In certain embodiments, for instance, the activated carbon layer may be directly positioned over the current collector and may optionally be the only layer of the carbonaceous coating. Examples of suitable activated carbon particles may include, for instance, coconut shell-based activated carbon, petroleum coke-based activated carbon, pitch-based activated carbon, polyvinylidene chloride-based activated carbon, phenolic resin-based activated carbon, polyacrylonitrile-based activated carbon, and activated carbon from natural sources such as coal, charcoal, or other natural organic sources.

In certain embodiments, it may be desired to selectively control certain aspects of the activated carbon particles, such as their particle size distribution, surface area, and pore size distribution to help improve ion mobility for certain types of electrolytes after being subjected to one or more charge-discharge cycles. For example, at least 50% by volume of the particles (D50 size) may have a size in the range of from about 0.01 micrometers or more, such as about 0.1 micrometers or more, such as about 0.5 micrometers or more, such as about 1 micrometer or more to about 30 micrometers or less, such as about 25 micrometers or less, such as about 20 micrometers or less, such as about 15 micrometers or less, such as about 10 micrometers or less. At least 90% by volume of the particles (D90 size) may likewise have a size in the range of from about 2 micrometers or more, such as about 5 micrometers or more, such as about 6 micrometers or more to about 40 micrometers or less, such as about 30 micrometers or less, such as about 20 micrometers or less, such as about 15 micrometers or less. The BET surface may also range from about 900 m²/g or more, such as about 1,000 m²/g or more, such as about 1,100 m²/g or more, such as about 1,200 m²/g or more to about 3,000 m²/g or less, such as about 2,500 m²/g or less, such as about 2,000 m²/g or less, such as about 1,800 m²/g or less, such as about 1,500 m²/g or less.

In addition to having a certain size and surface area, the activated carbon particles may also contain pores having a certain size distribution. For example, the amount of pores less than about 2 nanometers in size (i.e., “micropores”) may provide a pore volume of about 50 vol. % or less, such as about 40 vol. % or less, such as about 30 vol. % or less, such as about 20 vol. % or less, such as about 15 vol. % or less, such as about 10 vol. % or less, such as about 5 vol. % or less of the total pore volume. The amount of pores less than about 2 nanometers in size (i.e., “micropores”) may provide a pore volume of about 0 vol % or more, such as about 0.1 vol % or more, such as about 0.5 vol % or more, such as 1 vol % or more of the total pore volume. The amount of pores between about 2 nanometers and about 50 nanometers in size (i.e., “mesopores”) may likewise be about 20 vol. % or more, such as about 25 vol. % or more, such as about 30 vol. % or more, such as about 35 vol. % or more, such as about 40 vol. % or more, such as about 50 vol. % or more of the total pore volume. The amount of pores between about 2 nanometers and about 50 nanometers in size (i.e., “mesopores”) may be about 90 vol. % or less, such as about 80 vol. % or less, such as about 75 vol. % or less, such as about 65 vol. % or less, such as about 55 vol. % or less, such as about 50 vol. % or less of the total pore volume. Finally, the amount of pores greater than about 50 nanometers in size (i.e., “macropores”) may be about 1 vol. % or more, such as about 5 vol. % or more, such as about 10 vol. % or more, such as about 15 vol. % or more of the total pore volume. The amount of pores greater than about 50 nanometers in size (i.e., “macropores”) may be about 50 vol. % or less, such as about 40 vol. % or less, such as about 35 vol. % or less, such as about 30 vol. % or less, such as about 25 vol. % or less of the total pore volume. The total pore volume of the carbon particles may be in the range of from about 0.2 cm³/g or more, such as about 0.4 cm³/g or more, such as about, 0.5 cm³/g or more to about 1.5 cm³/g or less, such as about 1.3 cm³/g or less, such as about 1.0 cm³/g or less, such as about 0.8 cm³/g or less. The median pore width may be about 8 nanometers or less, such as about 5 nanometers or less, such as about 4 nanometers or less. The median pore width may be about 1 nanometer or more, such as about 2 nanometers or more. The pore sizes and total pore volume may be measured using nitrogen adsorption and analyzed by the Barrett-Joyner-Halenda (“BJH”) technique as is well known in the art.

One unique aspect of the present disclosure is that the electrodes need not contain a substantial amount of binders conventionally employed in ultracapacitor electrodes. That is, binders may be present in an amount of about 60 parts or less, such as about 40 parts or less, such as about 30 parts or less, such as about 25 parts or less, such as about 20 parts or less to about 1 part or more, such as about 5 parts or more per 100 parts of carbon in the carbonaceous coating. Binders may, for example, constitute about 15 wt. % or less, such as about 10 wt. % or less, such as about 8 wt. % or less, such as about 5 wt. % or less, such as about 4 wt. % or less of the total weight of the carbonaceous coating. The binders may constitute about 0.1 wt. % or more, such as about 0.5 wt. % or more, such as about 1 wt. % or more of the total weight of the carbonaceous coating.

Nevertheless, when employed, any of a variety of suitable binders can be used in the electrodes. For instance, water-insoluble organic binders may be employed in certain embodiments, such as styrene-butadiene copolymers, polyvinyl acetate homopolymers, vinyl-acetate ethylene copolymers, vinyl-acetate acrylic copolymers, ethylene-vinyl chloride copolymers, ethylene-vinyl chloride-vinyl acetate terpolymers, acrylic polyvinyl chloride polymers, acrylic polymers, nitrile polymers, fluoropolymers such as polytetrafluoroethylene or polyvinylidene fluoride, polyolefins, etc., as well as mixtures thereof. Water-soluble organic binders may also be employed, such as polyvinylpyrrolidone, polysaccharides and derivatives thereof. In one particular embodiment, the polysaccharide may be a nonionic cellulosic ether, such as alkyl cellulose ethers (e.g., methyl cellulose and ethyl cellulose); hydroxyalkyl cellulose ethers (e.g., hydroxyethyl cellulose, hydroxypropyl cellulose, hydroxypropyl hydroxybutyl cellulose, hydroxyethyl hydroxypropyl cellulose, hydroxyethyl hydroxybutyl cellulose, hydroxyethyl hydroxypropyl hydroxybutyl cellulose, etc.); alkyl hydroxyalkyl cellulose ethers (e.g., methyl hydroxyethyl cellulose, methyl hydroxypropyl cellulose, ethyl hydroxyethyl cellulose, ethyl hydroxypropyl cellulose, methyl ethyl hydroxyethyl cellulose and methyl ethyl hydroxypropyl cellulose); carboxyalkyl cellulose ethers (e.g., carboxymethyl cellulose); and so forth, as well as protonated salts of any of the foregoing, such as sodium carboxymethyl cellulose, ammonium carboxymethyl cellulose.

If desired, other materials may also be employed within an activated carbon layer of the carbonaceous materials. For example, in certain embodiments, a conductivity promoter may be employed to further increase electrical conductivity. Exemplary conductivity promoters may include, for instance, carbon black, graphite (natural or artificial), carbon nanotubes, nanowires or nanotubes, metal fibers, graphenes, etc., as well as mixtures thereof. Carbon black is particularly suitable in one embodiment. In another embodiment, carbon nanotubes are particularly suitable. When employed, conductivity promoters typically constitute about 60 parts or less, such as about 40 parts or less, such as about 30 parts or less, such as about 25 parts or less, such as about 20 parts or less to about 1 part or more, such as about 5 parts or more per 100 parts of carbon in the carbonaceous coating. Conductivity promoters may, for example, constitute about 15 wt. % or less, such as about 10 wt. % or less, such as about 8 wt. % or less, such as about 5 wt. % or less, such as about 4 wt. % or less of the total weight of the carbonaceous coating. The conductivity promoters may constitute about 0.1 wt. % or more, such as about 0.5 wt. % or more, such as about 1 wt. % or more of the total weight of the carbonaceous coating. Meanwhile, activated carbon particles likewise typically constitute 85 wt. % or more, such as about 90 wt. % or more, such as about 95 wt. % or more, such as about 97 wt. % or more of the total weight of the carbonaceous coating. The activated carbon particles may constitute less than 100 wt. %, such as about 99.5 wt. % or less, such as about 99 wt. % or less, such as about 98 wt. % or less of the total weight of the carbonaceous coating.

The particular manner in which a carbonaceous material is coated onto the sides of a current collector may vary as is well known to those skilled in the art, such as printing (e.g., rotogravure), spraying, slot-die coating, drop-coating, dip-coating, etc. In this regard, the electrodes may be formed by laminating a carbonaceous material, including a carbon film, on a current collector. Regardless of the manner in which it is applied, the resulting electrode is typically dried to remove moisture from the coating, such as at a temperature of about 100° C. or more, in some embodiments about 200° C. or more, and in some embodiments, from about 300° C. to about 500° C. The electrode may also be compressed (e.g., calendared) to optimize the volumetric efficiency of the ultracapacitor. After any optional compression, the thickness of each carbonaceous coating may generally vary based on the desired electrical performance and operating range of the ultracapacitor. Typically, however, the thickness of a coating is from about 20 to about 200 micrometers, 30 to about 150 micrometers, and in some embodiments, from about 40 to about 100 micrometers. Coatings may be present on one or both sides of a current collector. Regardless, the thickness of the overall electrode (including the current collector and the carbonaceous coating(s) after optional compression) is typically within a range of from about 20 to about 350 micrometers, in some embodiments from about 30 to about 300 micrometers, and in some embodiments, from about 50 to about 250 micrometers.

### Separator

As indicated above, the electrode assembly may include a separator positioned between the first electrode and the second electrode. The separator can enable electrical isolation of one electrode from another to help prevent an electrical short but still allow transport of ions between the two electrodes. In certain embodiments, for example, a separator may be employed that includes a cellulosic fibrous material (e.g., airlaid paper web, wet-laid paper web, etc.), nonwoven fibrous material (e.g., polymeric nonwoven webs, such as polyolefin nonwoven webs), woven fabrics, film (e.g., polyolefin film), etc. Cellulosic fibrous materials are particularly suitable for use in the ultracapacitor, such as those containing natural fibers, synthetic fibers, etc. Specific examples of suitable cellulosic fibers for use in the separator may include, for instance, hardwood pulp fibers, softwood pulp fibers, rayon fibers, regenerated cellulosic fibers, etc.

In one embodiment, the separator may be a hybrid separator. For instance, it may include a plurality of materials. In one embodiment, the hybrid separator may be a single layer. Such single layer may include two or more different materials (e.g., cellulosic fibrous material, nonwoven fibrous materials (e.g., polymers), etc.). In another embodiment, the hybrid separator may be a multilayer separator. In this regard, at least two of the layers within the multilayer may be formed from different materials. For instance, one layer of the multilayer may be a cellulosic fibrous material while another layer of the multilayer may be a nonwoven fibrous material, such as a polymeric material.

Regardless of the particular materials employed, the separator typically has a thickness of about 150 micrometers or less, such as about 100 micrometers or less, such as about 80 micrometers or less, such as about 50 micrometers or less, such as about 40 micrometers or less, such as about 30 micrometers or less. The separator may have a thickness of about 1 micrometer or more, such as about 5 micrometers or more, such as about 10 micrometers or more, such as about 20 micrometers or more.

### Nonaqueous Electrolyte

In addition, the ultracapacitor may also include an electrolyte within the package. As indicated herein, the electrolyte includes a solvent and an ionic liquid. The electrolyte is generally nonaqueous in nature and thus contains at least one nonaqueous solvent. To help extend the operating temperature range of the ultracapacitor, it is typically desired that the nonaqueous solvent have a relatively high boiling temperature, such as about 150° C. or more, such as about 200° C. or more, such as about 225° C. or more, such as about 250° C. or more, such as about 275° C. or more. The boiling temperature may be about 400° C. or less, such as about 375° C. or less, such as about 350° C. or less, such as about 325° C. or less, such as about 300° C. or less, such as about 275° C. or less, such as about 250° C. or less, such as about 225° C. or less.

As indicated herein, the electrolyte includes a solvent. Particularly suitable high boiling point solvents may include, for instance, cyclic carbonate solvents, such as ethylene carbonate, propylene carbonate, butylene carbonate, vinylene carbonate, etc. Propylene carbonate may particularly be suitable due to its high electric conductivity and decomposition voltage, as well as its ability to be used over a wide range of temperatures. Of course, other nonaqueous solvents may also be employed, either alone or in combination with a cyclic carbonate solvent. Examples of such solvents may include, for instance, open-chain carbonates (e.g., dimethyl carbonate, ethyl methyl carbonate, diethyl carbonate, etc.), aliphatic monocarboxylates (e.g., methyl acetate, methyl propionate, etc.), lactone solvents (e.g., butyrolactone valerolactone, etc.), nitriles (e.g., acetonitrile, glutaronitrile, adiponitrile, methoxyacetonitrile, 3-methoxypropionitrile, etc.), amides (e.g., N,N-dimethylformamide, N,N-diethylacetamide, N-methylpyrrolidinone), alkanes (e.g., nitromethane, nitroethane, etc.), sulfur compounds (e.g., sulfolane, dimethyl sulfoxide, etc.); and so forth.

In one embodiment, the solvent includes a first sulfur-containing compound and a second sulfur-containing compound. In some embodiments, the solvent may consist of or consist essentially of the first sulfur-containing compound and the second sulfur-containing compound. In some embodiments, the solvent may include a third sulfur-containing compound. For instance, the sulfur-containing compound may include a sulfolane, a sulfone, a sulfoxide, a sulfide, or a sulfite. In one embodiment, the sulfur-containing compound may include a sulfolane, a sulfone, or a sulfoxide. In a further embodiment, the sulfur-containing compound may include a sulfolane or a sulfone.

In one embodiment, at least one sulfur-containing compound may be a sulfolane. In general, a sulfolane may have the following general structure:

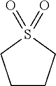

The sulfolane derivatives may include compounds wherein one or more of the hydrogen atoms is replaced by an organic radical, which may contain a polar grouping and more specifically may contain oxygen, nitrogen, sulfur and/or halide atoms. Sulfolane derivatives containing oxygen include hydroxy sulfolanes, sulfolanyl-ethers and -esters; sulfolane derivatives containing nitrogen include sulfolanyl-amines,-nitriles and nitro sulfolanes; sulfolane derivatives containing sulfur include sulfolanyl sulfides,-sulfoxides and -sulfones.

Some specific sulfolane derivatives include, but are not limited to, hydrocarbon-substituted sulfolanes such as alkyl sulfolanes preferably containing not more than about 10 carbon atoms; hydroxy sulfolanes such as 3-sulfolanol, 2-sulfolanol, 3-methyl-4-sulfolanol, 3-4-sulfolanediol; sulfolanyl ethers such as methyl-3-sulfolanyl ether, propyl-3-sulfolanyl ether, allyl-3-sulfolanyl ether, butyl-3-sulfolanyl ether, crotyl-3-sulfolanyl ether, isobutyl-3-sulfolanyl ether, methallyl-3-sulfolanyl ether, methyl vinyl carbinyl-3-sulfolanyl ether, amyl-3-sulfolanyl ether, hexyl-3-sulfolanyl ether, octyl-3-sulfolanyl ether, nonyl-3-sulfolanyl ether, glycerol alpha-gamma-diallyl-beta-3-sulfolanyl ether, tetrahydrofurfuryl-3-sulfolanyl ether, 3,3,5-tetramethyl-cyclohexyl-3-sulfolanyl ether, m-cresyl-3-sulfolanyl ethers, corresponding 2-sulfolanyl ethers, disulfolanyl ethers; sulfolanyl esters such as 3-sulfolanyl actetate, 3-sulfolanylcaproate, sulfolanyllaurate, sulfolanylpalmitate, sulfolanylstearate, sulfolanyloleate, sulfolanylpropionate, sulfolanylbutyrate; N-sulfolanes such as 3-sulfolanylamine, N-methyl-3-sulfolanylamine, N-ethyl-3-sulfolanylamine, N—N-dimethyl-3-sulfolanylamine, N-allyl-3-sulfolanylamine, N-butyl-3-sulfolanylamine, N-octyl-3-sulfolanylamine; sulfolanyl sulfides such as ethyl-3tertiary butyl-3-sulfolanyl sulfide, isobutyl-3-sulfolanyl sulfide, methallyl-3-sulfolanyl sulfide, di-3-sulfolanyl sulfide; sulfolanyl sulfones such as methyl-3-sulfolanyl sulfone, ethyl-3-sulfolanyl sulfone, propyl-3-sulfolanyl sulfone, amyl-3-sulfolanyl sulfone; and sulfolanyl halides such as 3-chloro-sulfolanyl halide, 3-4-dichloro-sulfolanyl halide, 3-chloro-4-methyl sulfolanes.

In one embodiment, the sulfolane may simply be sulfolane having the aforementioned structure. In this regard, the sulfolane may not be a sulfolane derivative.

In one embodiment, at least one sulfur-containing compound may be a sulfone. For instance, the sulfone may have the following general structure:

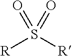

wherein R and R′ are an optionally substituted hydrocarbyl moiety. Generally, “hydrocarbyl” means a hydrocarbon substituent including aliphatic (straight-chain and branched-chain) and cyclic, such as alicyclic, and aromatic groups. For instance, the hydrocarbyl moiety may be an alkyl or an aryl.

In one embodiment, the hydrocarbyl moiety may be unsubstituted. In another embodiment, the hydrocarbyl moiety may be substituted. The moiety may include from 1 to 5 and, in some embodiments, 1 to 3 or 1 to 2 substituents. The substitution may include, but is not limited to, alkoxy, alkyl, amino, aryl, carboxyl, carboxyl ester, cyano, cycloalkyl, halo, hydroxy, nitro, oxo, sulfate, sulfonyl, thiol, etc. However, it should be understood that other substituent groups may also be utilized for substitutions. Furthermore, it should be understood that such substituent groups themselves may also include further substitutions. In one embodiment, the hydrocarbyl moiety may be an alkyl substituted with an aryl. Similarly, the hydrocarbyl moiety may be an aryl substituted with an alkyl.

In one embodiment, the sulfone may be referred to as an alkyl sulfone or a dialkyl sulfone. For instance, R and R′ may each independently be an alkyl group. The alkyl group may be a straight chain, branched chain, or cyclic monovalent saturated aliphatic hydrocarbyl group. The alkyl may have from 1 to 10 carbon atoms, such as from 1 to 6 carbon atoms, such as from 1 to 5 carbon atoms, such as from 1 to 4 carbon atoms, such as from 1 to 3 carbon atoms, such as from 1 to 2 carbon atoms, such as 1 carbon atom. The alkyl in one embodiment may be methyl.

In one embodiment, both R and R′ may be different. In another embodiment, both R and R′ may be the same. For example, they may both be alkyl. Even further, they may both be methyl.

The sulfone may include, but is not limited to, dimethyl sulfone, ethyl methyl sulfone, dipropyl sulfone, ethyl propyl sulfone, diethyl sulfone, dibutyl sulfone, propyl methyl sulfone, diisopropyl sulfone, isopropyl methyl sulfone, isopropyl ethyl sulfone, and combinations thereof. In this regard, in one embodiment, the sulfone may be dimethyl sulfone.

In one embodiment, at least one sulfur-containing compound may be a sulfoxide. In general, a sulfoxide may have the following general structure:

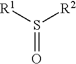

wherein R¹ and R² are an optionally substituted hydrocarbyl moiety. Generally, “hydrocarbyl” means a hydrocarbon substituent including aliphatic (straight-chain and branched-chain) and cyclic, such as alicyclic, and aromatic groups. For instance, the hydrocarbyl moiety may be an alkyl or an aryl.

In one embodiment, the hydrocarbyl moiety may be unsubstituted. In another embodiment, the hydrocarbyl moiety may be substituted. The moiety may include from 1 to 5 and, in some embodiments, 1 to 3 or 1 to 2 substituents. The substitution may include, but is not limited to, alkoxy, alkyl, amino, aryl, carboxyl, carboxyl ester, cyano, cycloalkyl, halo, hydroxy, nitro, oxo, sulfate, sulfonyl, thiol, etc. However, it should be understood that other substituent groups may also be utilized for substitutions. Furthermore, it should be understood that such substituent groups themselves may also include further substitutions. In one embodiment, the hydrocarbyl moiety may be an alkyl substituted with an aryl. Similarly, the hydrocarbyl moiety may be an aryl substituted with an alkyl.

In one embodiment, the sulfoxide may be referred to as an alkyl sulfoxide or a dialkyl sulfoxide. For instance, R¹ and R² may each independently be an alkyl group. The alkyl group may be a straight chain, branched chain, or cyclic monovalent saturated aliphatic hydrocarbyl group. The alkyl may have from 1 to 10 carbon atoms, such as from 1 to 6 carbon atoms, such as from 1 to 5 carbon atoms, such as from 1 to 4 carbon atoms, such as from 1 to 3 carbon atoms, such as from 1 to 2 carbon atoms, such as 1 carbon atom. The alkyl in one embodiment may be methyl.

In one embodiment, both R¹ and R² may be different. In another embodiment, both R¹ and R² may be the same. For example, they may both be alkyl. Even further, they may both be methyl. In this regard, such sulfoxide may be a dimethyl sulfoxide.

In one embodiment, at least one sulfur-containing compound may be a sulfide. In general, a sulfide is an inorganic anion of sulfur with the formula S²⁻ or a compound containing one or more S²⁻ ions.

The sulfide may include, but is not limited to, dimethyl sulfide, butyl sulfide, dibutyl sulfide, dipropyl sulfide, dioctyl sulfide, dibenzyl sulfide, diphenyl sulfide, ethylene sulfide, ethyl sulfide, methyl phenyl sulfide, ethyl vinyl sulfide, and combinations thereof.

In one embodiment, at least one sulfur-containing compound may be a sulfite. In general, a sulfite is a compound containing a sulfite ion SO₃²⁻.

The sulfite may include, but is not limited to, ethylene sulfite, 1,3-propylene sulfite, 1,2-propyleneglycol sulfite, dimethyl sulfite, vinyl ethylene sulfite, trimethylene sulfite, and combinations thereof.

Aside from the sulfur-containing compounds, the solvent may include other solvents generally known in the art in certain embodiments. These may include the aforementioned solvents. For instance, the solvent may further include, but is not limited to, cyclic carbonate solvents (e.g., ethylene carbonate, propylene carbonate, butylene carbonate, vinylene carbonate, etc.), open-chain carbonates (e.g., dimethyl carbonate, ethyl methyl carbonate, diethyl carbonate, etc.), aliphatic monocarboxylates (e.g., methyl acetate, methyl propionate, etc.), lactone solvents (e.g., butyrolactone valerolactone, etc.), nitriles (e.g., acetonitrile, glutaronitrile, adiponitrile, methoxyacetonitrile, 3-methoxypropionitrile, benzonitrile etc.), amides (e.g., N,N-dimethylformamide, N,N-diethylacetamide, N-methylpyrrolidinone), alkanes (e.g., nitromethane, nitroethane, etc.), and so forth.

The electrolyte also contains at least one ionic liquid, which may be dissolved in the solvent. While the concentration of the ionic liquid can vary, it is typically desired that the ionic liquid is present at a relatively high concentration. For example, the ionic liquid may be present in an amount of about 0.5 moles per liter (M) of the electrolyte or more, such as about 0.8 M or more, such as about 1.0 M or more, such as about 1.2 M or more, such as about 1.3 M or more, such as about 1.5 M or more. The ionic liquid may be present in an amount of about 3.0 M or less, such as about 2.5 M or less, such as about 2.0 M or less, such as about 1.8 M or less, such as about 1.5 M or less, such as about 1.4 M or less, such as about 1.3 M or less.

The ionic liquid is generally a salt having a relatively low melting temperature, such as about 400° C. or less, in some embodiments about 350° C. or less, in some embodiments from about 1° C. to about 100° C., and in some embodiments, from about 5° C. to about 50° C.

The salt contains a cationic species and counterion. The cationic species contains a compound having at least one heteroatom (e.g., nitrogen or phosphorous) as a “cationic center.” In this regard, the ionic liquid may include an organoquaternary ammonium compound, organoquaternary phosphonium compound, or a mixture thereof. Examples of such heteroatomic compounds include, for instance, unsubstituted or substituted organoquaternary ammonium compounds, such as ammonium (e.g., trimethylammonium, tetraethylammonium, etc.), pyridinium, pyridazinium, pyramidinium, pyrazinium, imidazolium, pyrazolium, oxazolium, triazolium, thiazolium, quinolinium, piperidinium, pyrrolidinium, quaternary ammonium spiro compounds in which two or more rings are connected together by a spiro atom (e.g., carbon, heteroatom, etc.), quaternary ammonium fused ring structures (e.g., quinolinium, isoquinolinium, etc.), and so forth. The organoquaternary ammonium (or phosphonium) compounds may be a compound having only an aliphatic chain, an alicyclic compound having an aliphatic chain and an aliphatic ring, and a spiro compound having only aliphatic rings. It should be noted that the spiro compound is a compound having a structure in which two rings share one atom of a tetrahedron structure.

In one particular embodiment, for example, the cationic species may be an N-spirobicyclic compound, such as symmetrical or asymmetrical N-spirobicyclic compounds having cyclic rings. One example of such a compound has the following structure:

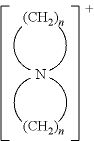

wherein m and n are independently a number from 3 to 7, and in some embodiments, from 4 to 5 (e.g., pyrrolidinium or piperidinium).

Suitable counterions for the cationic species may likewise include halogens (e.g., chloride, bromide, iodide, etc.); sulfates or sulfonates (e.g., methyl sulfate, ethyl sulfate, butyl sulfate, hexyl sulfate, octyl sulfate, hydrogen sulfate, methane sulfonate, dodecylbenzene sulfonate, dodecylsulfate, trifluoromethane sulfonate, heptadecafluorooctanesulfonate, sodium dodecylethoxysulfate, etc.); sulfosuccinates; amides (e.g., dicyanamide); imides (e.g., bis(pentafluoroethyl-sulfonyl)imide, bis(trifluoromethylsulfonyl)imide, bis(trifluoromethyl)imide, etc.); borates (e.g., tetrafluoroborate, tetracyanoborate, bis[oxalato]borate, bis[salicylato]borate, etc.); phosphates or phosphinates (e.g., hexafluorophosphate, diethylphosphate, bis(pentafluoroethyl)phosphinate, tris(pentafluoroethyl)-trifluorophosphate, tris(nonafluorobutyl) trifluorophosphate, etc.); antimonates (e.g., hexafluoroantimonate); aluminates (e.g., tetrachloroaluminate); fatty acid carboxylates (e.g., oleate, isostearate, pentadecafluorooctanoate, etc.); cyanates; acetates; and so forth, as well as combinations of any of the foregoing. In some embodiments, the counterion that may construct the salt may be exemplified by PF₆−, BF₄−, N(CF₃SO₃)₂−, and C(CF₃SO₃)₃−.

Several examples of suitable ionic liquids may include, for instance, spiro-(1,1′)-bipyrrolidinium tetrafluoroborate, triethylmethyl ammonium tetrafluoroborate, tetraethyl ammonium tetrafluoroborate, spiro-(1,1′)-bipyrrolidinium iodide, triethylmethyl ammonium iodide, tetraethyl ammonium iodide, methyltriethylammonium tetrafluoroborate, tetrabutylammonium tetrafluoroborate, tetraethylammonium hexafluorophosphate, 5-azoniaspiro[4.4]nonane tetrafluoroborate (spiro-(1,1′)-bipyrrolidinium: SBP-BF₄), 6-azoniaspiro[5.5]undecane tetrafluoroborate, 3-azoniaspiro[2.6]nonane tetrafluoroborat, 1,1-dimethylpyrrolidinium tetrafluoroborate, etc. Further, examples of the quaternary phosphonium based ionic liquids include 5-phosphonylspiro[4.4]nonane tetrafluoroborate. In this regard, a particular suitable ionic liquid may include a tetrafluoroborate spiro quaternary compound, such as a tetrafluoroborate spiro quaternary ammonium and/or a tetrafluoroborate spiro quaternary phosphonium.

In one embodiment, the ionic liquid may include a cyclic compound. For instance, as indicated above, the ionic liquid may include a spiro compound. However, it should be understood that the ionic liquid may not include a spiro compound yet may include a cyclic compound (e.g., a pyrrolidinium, such as 1,1-dimethylpyrrolidinium tetrafluoroborate).

Furthermore, in one embodiment, the electrolyte may include a lithium metal salt. For instance, a non-limiting list of suitable lithium metal salts that can be utilized include LiCF₃SO₃, LiN(CF₃SO₂)₂, LiNO₃, LiF, LiPF₆, LIBF₄, LiI, LiBr, LiSCN, LiClO₄, LiAlCl₄, LiB(C₂O₄)₂, LiB(C₆H₅)₄, LiBF₂(C₂O₄), LiN(SO₂F)₂, LiPF₃(C₂F₅)₃, LiPF₄(CF₃)₂, LiPF₄(C₂O₄), LiPF₃(CF₃)₃, LiSO₃CF₃, LiAsF₆, and mixtures thereof. In one particular embodiment, the lithium metal salt may include LiF.

In one embodiment, the lithium metal salt may include one having a fluorine atom. For instance, the lithium metal salt may include a fluoride. In particular, the lithium metal salt may include lithium fluoride.

The electrolyte as disclosed herein may have a particular melting point. For instance, in one embodiment, the electrolyte may be a liquid at room temperature. In this regard, the melting point may be −70° C. or more, such as −60° C. or more, such as −50° C. or more, such as −40° C. or more, such as −30° C. or more, such as −20° C. or more, such as −10° C. or more, such as 0° C. or more, such as 10° C. or more, such as 20° C. or more, such as 30° C. or more, such as 40° C. or more, such as 50° C. or more, such as 60° C. or more, such as 70° C. or more, such as 80° C. or more, such as 90° C. or more. The melting point may be 120° C. or less, such as 110° C. or less, such as 100° C. or less, such as 90° C. or less, such as 80° C. or less, such as 70° C. or less, such as 60° C. or less, such as 50° C. or less, such as 40° C. or less, such as 30° C. or less, such as 20° C. or less, such as 10° C. or less, such as 0° C. or less, such as −10° C. or less, such as −20° C. or less.

In the electrolyte, the solvent may constitute a majority based on the weight of the electrolyte. For instance, the solvent may constitute 40 wt. % or more, such as 45 wt. % or more, such as 50 wt. % or more, such as 55 wt. % or more, such as 60 wt. % or more, such as 65 wt. % or more, such as 70 wt. % or more of the electrolyte. The solvent may constitute less than 100 wt. %, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less of the electrolyte.

As indicated above, the solvent may include a first sulfur-containing compound and a second-sulfur containing compound. In this regard, the first sulfur-containing compound may be present in the electrolyte in an amount of 30 wt. % or more, such as 35 wt. % or more, such as 40 wt. % or more, such as 45 wt. % or more, such as 50 wt. % or more, such as 55 wt. % or more, such as 60 wt. % or more based on the weight of the electrolyte. The first sulfur-containing compound may be present in the electrolyte in an amount 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less based on the weight of the electrolyte.

The second sulfur-containing compound may be present in the electrolyte in an amount of 2 wt. % or more, such as 5 wt. % or more, such as 8 wt. % or more, such as 10 wt. % or more, such as 13 wt. % or more, such as 15 wt. % or more, such as 18 wt. % or more, such as 20 wt. % or more, such as 25 wt. % or more, such as 30 wt. % or more based on the weight of the electrolyte. The second sulfur-containing compound may be present in the electrolyte in an amount 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less such as 40 wt. % or less, such as 35 wt. % or less, such as 30 wt. % or less, such as 26 wt. % or less, such as 24 wt. % or less, such as 20 wt. % or less, such as 18 wt. % or less, such as 16 wt. % or less, such as 14 wt. % or less, such as 12 wt. % or less based on the weight of the electrolyte.

The first sulfur-containing compound may constitute a majority of the solvent. For instance, the first sulfur-containing compound may be present in an amount of 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the solvent. The first sulfur-containing compound may be present in an amount of less than 100 wt. %, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less based on the weight of the solvent.

Accordingly, the second sulfur-containing compound may constitute a minority of the solvent. For instance, the second sulfur-containing compound may be present in an amount of 50 wt. % or less (such as less than 50 wt. %), such as 45 wt. % or less, such as 40 wt. % or less, such as 35 wt. % or less, such as 30 wt. % or less, such as 25 wt. % or less, such as 20 wt. % or less, such as 15 wt. % or less based on the weight of the solvent. The second sulfur-containing compound may be present in an amount more than 0 wt. %, such as 2 wt. % or more, such as 5 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more based on the weight of the solvent.

Further, the solvent may include the first sulfur-containing compound and the second sulfur-containing compound in an amount of 80 wt. % or more, such as 85 wt. % or more, such as 90 wt. % or more, such as 93 wt. % or more, such as 95 wt. % or more, such as 96 wt. % or more, such as 97 wt. % or more, such as 98 wt. % or more, such as 99 wt. % or more, such as 99.5 wt. % or more based on the weight of the solvent. For instance, the solvent may include the first sulfur-containing compound and the second sulfur-containing compound in an amount of more than 90 wt. % based on the weight of the solvent.

As indicated herein, the electrolyte may be nonaqueous. Accordingly, water may not be present. In this regard, water may be present in an amount of 1 wt. % or less, such as 0.8 wt. % or less, such as 0.6 wt. % or less, such as 0.5 wt. % or less, such as 0.4 wt. % or less, such as 0.3 wt. % or less, such as 0.2 wt. % or less, such as 0.1 wt. % or less, such as 0.09 wt. % or less, such as 0.08 wt. % or less, such as 0.07 wt. % or less, such as 0.06 wt. % or less, such as 0.05 wt. % or less, such as 0.04 wt. % or less, such as 0.03 wt. % or less, such as 0.02 wt. % or less, such as 0.01 wt. % or less, such as 0.009 wt. % or less, such as 0.008 wt. % or less, such as 0.007 wt. % or less, such as 0.006 wt. % or less, such as 0.005 wt. % or less based on the weight of the electrolyte.

Regardless of the number of solvents present within the electrolyte, it should be understood that the total weight percentage of all of the solvents should be about 100 wt. % based on the combination of the solvents present within the electrolyte.

In addition, the ionic liquid may comprise less of the electrolyte than the solvent. For instance, the ionic liquid may be present in an amount of 10 wt. % or more, such as 15 wt. % or more, such as 20 wt. % or more, such as 25 wt. % or more, such as 30 wt. % or more, such as 35 wt. % or more, such as 40 wt. % or more based on the weight of the electrolyte. The ionic liquid may be present in an amount of 55 wt. % or less, such as 50 wt. % or less, such as 45 wt. % or less, such as 40 wt. % or less, such as 35 wt. % or less, such as 30 wt. % or less based on the weight of the electrolyte.

Further, if a lithium metal salt is utilized, it may also comprise less of the electrolyte than the solvent. In particular, the metal salt may be present in the electrolyte in a small amount. For instance, the metal salt may be present in an amount of 1 wt. % or less, such as 0.8 wt. % or less, such as 0.6 wt. % or less, such as 0.5 wt. % or less, such as 0.4 wt. % or less, such as 0.3 wt. % or less, such as 0.2 wt. % or less, such as 0.1 wt. % or less, such as 0.09 wt. % or less, such as 0.08 wt. % or less, such as 0.07 wt. % or less, such as 0.06 wt. % or less, such as 0.05 wt. % or less, such as 0.04 wt. % or less, such as 0.03 wt. % or less, such as 0.02 wt. % or less, such as 0.01 wt. % or less, such as 0.009 wt. % or less, such as 0.008 wt. % or less, such as 0.007 wt. % or less, such as 0.006 wt. % or less, such as 0.005 wt. % or less based on the weight of the electrolyte. The metal salt may be present in an amount of more than 0 wt. %, such as 0.0001 wt. % or more, such as 0.0002 wt. % or more, such as 0.0003 wt. % or more, such as 0.0004 wt. % or more, such as 0.0005 wt. % or more, such as 0.0006 wt. % or more, such as 0.0007 wt. % or more, such as 0.0008 wt. % or more, such as 0.0009 wt. % or more, such as 0.001 wt. % or more, such as 0.002 wt. % or more, such as 0.003 wt. % or more, such as 0.004 wt. % or more, such as 0.005 wt. % or more, such as 0.006 wt. % or more, such as 0.007 wt. % or more, such as 0.008 wt. % or more, such as 0.009 wt. % or more, such as 0.01 wt. % or more based on the weight of the electrolyte.

### Package

As indicated herein, the ultracapacitor includes a package within which the electrode assembly and electrolyte are housed. Referring to FIGS. 1A-1C and 2A-2J, the package 50 has a lid 82, a base 56, and sidewalls 52 that extend in a direction generally perpendicular to the base 56. The base 56 defines an inner base surface 56a, for example adjacent the interior cavity 58, and an outer base surface 56b opposite the inner base surface 56a. The interior cavity 58 is defined between an inner base surface 56a of the base 56 and the sidewalls 52 within which the electrode assembly 72 can be positioned.

As shown, the sidewalls 52 extend in a direction generally perpendicular to the base 56 to define a first upper end 54a. As shown in FIG. 2A, the sidewalls 52 may extend to define one upper end. In another embodiment, the sidewalls 52 may extend a direction generally perpendicular to the base 56 to define one or more upper ends, such as two or more upper ends, such as two upper ends. For instance, as shown in FIGS. 2B-2J, the sidewalls 52 extend in a direction generally perpendicular to the base 56 to define a first upper end 54a and a second upper end 54b. In the direction of extension, the first upper end 54a may not extend to such a degree as the second upper end 54b. In this regard, the height of the first upper end 54a may be less than the height of second upper end 54b. Accordingly, such first upper end 54a and second upper end 54b may provide a step configuration. Further, such first upper end 54a may be positioned closer to the interior cavity 58 than the second upper end 54b.

Further, such upper end(s) may extend in a direction generally parallel to the inner surface 56a of the base 56. For instance, in one embodiment, the first upper end 54a may extend in a direction generally parallel to the inner surface 56a of the base 56. In one embodiment, the second upper end 54b may extend in a direction generally parallel to the inner surface 56a of the base 56. In one embodiment, a respective upper end may not extend in a direction generally parallel to the inner surface 56a of the base 56. For instance, the first upper end 54a may extend in a direction generally non-parallel to the inner surface 56a of the base as illustrated in FIGS. 2E-2J. In FIGS. 2E-2G, the first upper end 54a extends in an angle from the second sidewall inner surface 52b toward the lid 82 (or in a direction away from the base 56). In FIGS. 2H-2J, the first upper end 54a extends in an angle from the second sidewall inner surface 52b toward the base 56 (or in a direction away from the base 82).

Beginning from the inner base surface 56a of the base 56, the height of the sidewalls 52 to the first upper end 54a may be 50% or more, such as 55% or more, such as 60% or more, such as 65% or more, such as 70% or more, such as 75% or more, such as 80% or more, such as 85% or more the height of the sidewalls 52 from the inner base surface 56a of the base 56 to the second upper end 54b. The height of the sidewalls 52 from the inner base surface 56a of the base 56 to the first upper end 54a may be less than 100%, such as 98% or less, such as 95% or less, such as 93% or less, such as 90% or less, such as 88% or less, such as 85% or less, such as 83% or less, such as 80% or less, such as 78% or less, such as 75% or less the height of the sidewalls 52 from the inner base surface 56a of the base 56 to the second upper end 54b. As indicated and for the sake of clarity, such height may be determined from the inner base surface 56a of the base 56 to the respective upper end, in particular the edge of the respective upper end closest to the interior cavity 58. Or, in other words, the height may be determined from the inner base surface 56a of the base 56 to the intersection of the respective upper end and the respective sidewall inner surface. For instance, the height of the first upper end 54a may be the distance from the inner base surface 56a of the base to the intersection (or point or edge) of the first upper end 54a and the first sidewall inner surface 52a. Meanwhile, the height of the first upper end 54a may be the distance (i.e., vertical distance) from the inner base surface 56a of the base to the intersection (or point or edge) (in a vertical direction) of the second upper end 54b and the second sidewall inner surface 52b. Regarding these dimensions, it should be understood that the height is measured in a generally perpendicular direction from the inner base surface 56a and not in a diagonal manner (e.g., from the inner base surface 56a directly to the intersection point of the second upper end 54b and the second sidewall inner surface 52b.

Furthermore, the sidewalls 52 may include a sidewall inner surface facing the interior cavity 58 of the package 50. For instance, as illustrated in FIG. 2A, the sidewalls 52 may extend to a first upper end 54a. In this regard, such sidewall inner surface of the sidewalls 52 may be referred to as a first sidewall inner surface 52a of the sidewalls 52 as it extends from the base 56, in particular to the first upper end 54a. However, as illustrated in FIGS. 2B-2J, when the sidewalls include a first upper end 54a and a second upper end 54b, the sidewalls may include a first sidewall inner surface 52a and a second sidewall inner surface 52b. For instance, the first sidewall inner surface 52a may extend from the inner base surface 56a of the base 56 to the first upper end 54a. Meanwhile, the second sidewall inner surface 52b may extend from the first upper end 54a to the second upper end 54b. Further, such first sidewall inner surface 52a may be positioned closer to the interior cavity 58 than the second sidewall inner surface 52b.

When referring to the height of the respective upper ends, the height of the first upper end 54a may refer to the distance of the first sidewall inner surface 52a extending from the inner base surface 56a of the base 56 to the first upper end 54a, in particular the edge of the first upper end 54a closest to the interior cavity 58. Meanwhile, the height of the second upper end 54b may refer to the total distance of the first sidewall inner surface 52a extending from the inner base surface 56a of the base 56 to the second upper end 54b, in particular the edge of the second upper end 54b closest to the interior cavity 58. In some embodiments, the height of the second upper end 54b may refer to the total distance of the first sidewall inner surface 52a extending from the inner base surface 56a of the base 56 to the first upper end 54a and the second sidewall inner surface 52b extending from the first upper end 54a to the second upper end 54b. Regarding such latter embodiments, they may be applicable in instances wherein the first upper end 54a is generally parallel to the inner base surface 56a.

The package 50 may also include a lid 82 for enclosing the interior cavity 58 of the package 50. For instance, in one embodiment as illustrated in FIG. 2A, the lid 82 may be disposed on the first upper end 54a of the sidewalls 52 to seal the electrode assembly 72 and electrolyte within the interior cavity 58 of the package 50. As illustrated, the lid 82 may not contact a sidewall inner surface in one embodiment.

In other embodiments as illustrated in FIGS. 2B-2J, the package may contain a first upper end 54a and a second upper end 54b. The lid 82 may be disposed on the first upper end 54a of the sidewalls 52 to seal the electrode assembly 72 and electrolyte within the interior cavity 58 of the package 50. In a further embodiment, although not illustrated, the lid 82 may be disposed on the first upper end 54a and the second upper end 54b of the sidewalls 52 to seal the electrode assembly 72 and electrolyte within the interior cavity 58 of the package 50. In one embodiment, without intending to be limited, as the package 50 is sealed, such as the lid 82 being sealed to the sidewalls 52 of the package 50, to the extent the first upper end 54a may be angular in fashion, the sealing or welding of the lid 82 to the sidewalls 52 may allow for general melting or softening of the material of the first upper end 54a. In some embodiments, such melting or softening may then allow for the first upper end 54a to extend in a direction generally parallel to the inner base surface 56a. In this regard, the ultracapacitor as defined herein may be formed from a package 50 wherein the first upper end 54a extends in an angular fashion or not generally parallel with respect to the inner base surface 56a. However, upon sealing the package, in certain embodiments, the first upper end 54a may extend in a direction generally parallel with respect to the inner base surface 56a. However, in certain other embodiments, it should be understood that even after sealing, the first upper end 54a may not extend in a direction generally parallel with respect to the inner base surface 56a.

In this regard, the package 50 of the sealed ultracapacitor may have a first upper end 54a that may have a configuration the same as the first upper end 54a of the package 50 utilized in forming the ultracapacitor in one embodiment. In another embodiment, the package 50 of the sealed ultracapacitor may have a first upper end 54a that may have a configuration different from the first upper end 54a of the package 50 utilized in forming the ultracapacitor. Regardless, the ultracapacitor, whether or not sealed, may have a first upper end 54a as described herein. Further, in one embodiment, one or more of the upper end(s) may extend in a direction generally parallel to an inner surface and/or an outer surface of the lid 82. For instance, in one embodiment, the second upper end 54b may extend in a direction generally parallel to an inner surface and/or an outer surface of the lid 82. In another embodiment, the second upper end 54b may extend in a direction generally parallel to an inner surface 56a and/or an outer surface 56b of the base 56. Similarly, in one embodiment, the first upper end 54a may extend in a direction generally parallel to an inner surface and/or an outer surface of the lid 82. In another embodiment, the first upper end 54a may extend in a direction generally parallel to an inner surface 56a and/or an outer surface 56b of the base 56. In this regard, wherein the first upper end 54a extends in a direction generally parallel may be illustrated in FIGS. 2B-2D.

However, in one embodiment, the first upper end 54a may not extend in a direction generally parallel to the inner surface and/or the outer surface of the lid 82. Related, the first upper end 54a may not extend in a direction generally parallel to the inner base surface 56a and/or the outer base surface 56b of the base 56. For instance, such embodiments may be illustrated in FIGS. 2E-2J. In FIGS. 2E-2G, the first upper end 54a may be angled such that the height along the first upper end 54a, as measured from the inner base surface 56a of the base 56, increases from the point where the second sidewall inner surface 52b begins (as a contact point with the first upper end 54a) to the point where the first sidewall inner surface 54a ends from extending from the inner base surface 56a of the base 56. In FIGS. 2H-2J, the first upper end 54a may be angled such that the height along the first upper end 54a, as measured from the inner base surface 56a of the base 56, decreases from the point where the second sidewall inner surface 52b begins (as a contact point with the first upper end 54a) to the point where the first sidewall inner surface 54a ends from extending from the inner base surface 56a of the base 56.

If desired, a sealing member (not shown) may be disposed between the lid 82 and the sidewalls 52 to help provide a good seal. In particular, a sealing member may be disposed between the respective upper end (54a and/or 54b) and the lid 82. In one embodiment, a sealing member may be disposed between the respective sidewall inner surface (52a and/or 52b) and the lid 82. In a further embodiment, a sealing member may be disposed between a respective upper end (54a and/or 54b) and a respective sidewall inner surface (52a and/or 52b) and the lid 82. In one embodiment, for example, the sealing member may include a glass-to-metal seal, Kovar® ring (Goodfellow Cambridge, Ltd.), etc.

In forming the seal, a certain amount of desired contact may be present between the lid and the sidewalls. For instance, the contact area may be about 10 mm² or more, such as about 15 mm² or more, such as about 20 mm² or more, such as about 25 mm² or more, such as about 30 mm² or more, such as about 35 mm² or more, such as about 40 mm² or more, such as about 45 mm² or more, such as about 50 mm² or more, such as about 55 mm² or more, such as about 60 mm² or more, such as about 65 mm² or more, such as about 70 mm² or more, such as about 75 mm² or more, such as about 80 mm² or more, such as about 85 mm² or more, such as about 90 mm² or more, such as about 95 mm² or more, such as about 100 mm² or more, such as about 120 mm² or more, such as about 140 mm² or more, such as about 160 mm² or more, such as about 180 mm² or more, such as about 200 mm² or more, such as about 220 mm² or more, such as about 240 mm² or more, such as about 260 mm² or more, such as about 280 mm² or more. The contact area between the lid and the sidewalls may be about 300 mm² or less, such as about 290 mm² or less, such as about 270 mm² or less, such as about 250 mm² or less, such as about 230 mm² or less, such as about 210 mm² or less, such as about 190 mm² or less, such as about 170 mm² or less, such as about 150 mm² or less, such as about 130 mm² or less, such as about 110 mm² or less, such as about 100 mm² or less, such as about 90 mm² or less, such as about 80 mm² or less, such as about 70 mm² or less, such as about 60 mm² or less, such as about 50 mm² or less, such as about 40 mm² or less, such as about 30 mm² or less, such as about 20 mm² or less. For the sake of clarity, such contact area may refer to the area in contact or in common between the lid and the sidewalls of the package.

In one embodiment, such contact with the lid may be with an upper end, such as a first upper end. Such contact may be on an upper end, such as a first upper end. In one particular embodiment, such contact with the lid may be solely with and/or on such upper end, such as the first upper end. In another embodiment, such contact with the lid may be with a second upper end. Such contact may be on an upper end, such as a second upper end. In one particular embodiment, such contact with the lid may be solely with and/or on such second upper end.

In another embodiment, such contact with the lid may be on a sidewall inner surface, such as a first sidewall inner surface. Such contact may be with a sidewall inner surface, such as a first sidewall inner surface. Alternatively, such contact with the lid may be based on a second sidewall inner surface. Such contact may be with a sidewall inner surface, such as a second sidewall inner surface. In another embodiment, such contact with the lid may be based on the first sidewall inner surface and the second sidewall inner surface.

In a further embodiment, such contact with the lid may be based on one or more upper ends and one or more sidewall inner surfaces. For instance, such contact with the lid may be based on a first upper end and/or second upper end as well as a first sidewall inner surface and/or second sidewall inner surface. In one particular embodiment, such contact with the lid may be based on a combination of the first sidewall inner surface, the second sidewall inner surface, and the second upper end.

When making such contact with an upper end, such as a first upper end, the contact area, based on the surface area of the upper end, such as the first upper end, may be about 50% or more, such as about 55% or more, such as about 60% or more, such as about 65% or more, such as about 70% or more, such as about 75% or more, such as about 80% or more, such as about 85% or more, such as about 90% or more, such as about 95% or more, such as about 98% or more, such as about 99% or more, such as about 100%. The contact area based on the surface area of the upper end, such as the first upper end, may be 100% or less, such as about 99% or less, such as about 98% or less, such as about 95% or less.

As indicated herein, the package 50 includes a lid 82. In one embodiment, the lid 82 may have a boss configuration. For instance, such a configuration is illustrated in FIGS. 2C-2D, 2F-2G, and 2I-2J wherein the lid extends further into the interior cavity 58 of the package 50 extending past the first upper end 54a toward or in the direction of the inner base surface 56a of the base 56. While illustrated in FIGS. 2C-2D, 2F-2G, and 2I-2J having a first upper end 54a and a second upper end 54b, it should be understood that such a configuration may also be utilized with a lid 82 wherein the sidewalls 52 only have a first upper end 54a as illustrated in FIG. 2A.

When extending past the first upper end 54a, the lid 82 may contact the first sidewall inner surface 52a. In one embodiment, the lid 82 may contact both sidewall inner surfaces, first sidewall inner surface 52a and second sidewall inner surface 52b. In addition, the lid 82 may also contact the first upper end 54a. In another embodiment, the lid 82 may also contact the second upper end 54b. In this regard, the lid 82 may contact the first upper end 54a and the second upper end 54b.

In an even further embodiment, such as illustrated in FIGS. 2D, 2G, and 2J, the lid 82 may have a lid cavity 88 adjacent the interior cavity 58 of the package 50. Such lid cavity 88 is represented by the region below a bottom surface of the lid 82 and above the dashed line as illustrated. For instance, such lid cavity 88 may be formed by shaping the lid 82 in a particular manner. Further, providing such a lid cavity 88 may allow for a larger electrode assembly 72 thereby minimizing potential contact with the lid 82. For instance, in addition to being provided within the interior cavity 58 of the package 50, the electrode assembly 72 may extend into the lid cavity 88. Also, the electrolyte may be present within the lid cavity 88.

The height of the sidewalls 52 is generally such that the lid 82 does not contact any surface of the electrode assembly 72 disposed within the interior cavity 58 of the package 50. When placed in the desired position, the lid 82 may be sealed to the sidewalls 52 using known techniques, such as welding (e.g., resistance welding, laser welding, ultrasonic welding, etc.), soldering, etc. In one embodiment, the lid 82 may be sealed to the sidewalls using ultrasonic welding. As indicated herein, such sealing (welding) may result in melting or softening of the material, such as a polymer, utilized in forming the sidewalls 52 of the package 50. In this regard, in certain embodiments, upon sealing and to the extent a first upper end 54a extends in a direction generally non-parallel to a respective inner or outer surface of the lid 82 or a respective inner or outer base surface of the base 56, such softening may allow for the lid 82 to contact the first upper end 54a in a fashion that may then allow for such first upper end 54a to extend in a direction generally parallel to a respective inner or outer surface of the lid 82 or a respective Inner or outer base surface of the base 56.

As indicated above, a certain contact area may exist between the lid and the sidewalls, particularly a respective upper end and/or sidewall inner surface. Of such particular contact area, 40% or more, such as 45% or more, such as 50% or more, such as 55% or more, such as 60% or more, such as 65% or more, such as 70% or more, such as 75% or more, such as 80% or more, such as 85% or more, such as 90% or more, such as 95% or more of the contact area may form a bond, such as due to a weld. Such area of the bond may be 100% or less, such as 95% or less, such as 90% or less, such as 85% or less, such as 80% or less, such as 75% or less, such as 70% or less, such as 65% or less, such as 60% or less, such as 55% or less of the contact area between the lid and the sidewalls.

In this regard, the bond area may be about 10 mm² or more, such as about 15 mm² or more, such as about 20 mm² or more, such as about 25 mm² or more, such as about 30 mm² or more, such as about 35 mm² or more, such as about 40 mm² or more, such as about 45 mm² or more, such as about 50 mm² or more, such as about 55 mm² or more, such as about 60 mm² or more, such as about 65 mm² or more, such as about 70 mm² or more, such as about 75 mm² or more, such as about 80 mm² or more, such as about 85 mm² or more, such as about 90 mm² or more, such as about 95 mm² or more, such as about 100 mm² or more, such as about 120 mm² or more, such as about 140 mm² or more, such as about 160 mm² or more, such as about 180 mm² or more, such as about 200 mm² or more, such as about 220 mm² or more, such as about 240 mm² or more, such as about 260 mm² or more, such as about 280 mm² or more. The bond area between the lid and the sidewalls may be about 300 mm² or less, such as about 290 mm² or less, such as about 270 mm² or less, such as about 250 mm² or less, such as about 230 mm² or less, such as about 210 mm² or less, such as about 190 mm² or less, such as about 170 mm² or less, such as about 150 mm² or less, such as about 130 mm² or less, such as about 110 mm² or less, such as about 100 mm² or less, such as about 90 mm² or less, such as about 80 mm² or less, such as about 70 mm² or less, such as about 60 mm² or less, such as about 50 mm² or less, such as about 40 mm² or less, such as about 30 mm² or less, such as about 20 mm² or less. For the sake of clarity, such bond area may refer to the area in contact or in common between the lid and the sidewalls of the package wherein a bond is formed, such as by welding.

Meanwhile, any of a variety of different materials may be used to form the sidewalls 52 and the base 56 of the package 50. In addition, in one embodiment, the same material may be utilized to form the lid 82 of the package 50. In this regard, the entirety of the package 50 (sidewalls 52, base 56, and lid 82) may be formed from the same material. These materials may include a metal, a polymer, a ceramic, etc. In one embodiment, for example, the material may include a ceramic material. Such ceramic material may be utilized to form the sidewalls and/or base. Alternatively, such ceramic material may be utilized to form the lid. The ceramic material may include aluminum nitride, aluminum oxide, silicon oxide, magnesium oxide, calcium oxide, glass, etc., as well as combinations thereof. In other embodiments, the material may include a metal. Such metal may be utilized to form the sidewalls and/or base. Alternatively, such metal may be utilized to form the lid. The metal may include tantalum, niobium, aluminum, nickel, hafnium, titanium, copper, silver, steel (e.g., stainless), alloys thereof (e.g., electrically conductive oxides), composites thereof (e.g., metal coated with electrically conductive oxide), and so forth.

In one particular embodiment, the package or a part thereof (e.g., base, sidewalls, and/or lid) may be formed from a polymer, in particular a thermoplastic polymer. In one embodiment, the base and sidewalls may be formed from such polymer. In such embodiment, the base and sidewalls may be integrally formed using general molding techniques (e.g., injection molding, extrusion molding, etc.). In another embodiment, the base, sidewalls, and lid may be formed from such polymer. The lid may also be formed using general molding techniques (e.g., injection molding, extrusion molding, etc.).

The polymer may be a liquid crystalline polymer. In general, a liquid crystalline polymer may be melt-processable thereby allowing for general molding processes to be utilized in forming any part of the package mentioned above. Such polymer may include a liquid crystalline polyester, a liquid crystalline polyester amide, a liquid crystalline polyester carbonate, or a mixture thereof. In one embodiment, such polymer may include a liquid crystalline polyester. In another embodiment, such polymer may include a liquid crystalline polyester amide.

In addition, the liquid crystalline polymer may be an aromatic liquid crystalline polymer. For instance, it may be an aromatic liquid crystalline polyester, an aromatic liquid crystalline polyester amide, an aromatic liquid crystalline polyester carbonate, or a mixture thereof. In one embodiment, such polymer may include an aromatic liquid crystalline polyester. In another embodiment, such polymer may include an aromatic liquid crystalline polyester amide.

The liquid crystalline polymer may contain repeating units formed from one or more aromatic dihydroxy compounds, one or more aromatic dicarboxylic acids, one or more aromatic hydroxycarboxylic acids, one or more aromatic amines, one or more aromatic hydroxyamines, one or more aromatic aminocarboxylic acids, etc., or a combination thereof. In one embodiment, the liquid crystalline polymer may contain repeating units formed from one or more aromatic dihydroxy compounds, one or more aromatic dicarboxylic acids, one or more aromatic hydroxycarboxylic acids, or a mixture thereof. In a further embodiment, the liquid crystalline polymer may be made from at least two of the one or more aromatic dihydroxy compounds, the one or more aromatic dicarboxylic acids, and the one or more aromatic hydroxycarboxylic acids. In another embodiment, the liquid crystalline polymer may be made from all three of the one or more aromatic dihydroxy compounds, the one or more aromatic dicarboxylic acids, and the one or more aromatic hydroxycarboxylic acids.

The liquid crystalline polymer may, for example, contain one or more aromatic ester repeating units, typically in an amount of about 50 mol. % or more, such as about 60 mol. % or more, such as about 70 mol. % or more, such as about 75 mol. % or more, such as about 80 mol. % or more, such as about 85 mol. % or more, such as about 90 mol. % or more, such as about 95 mol. % or more of the polymer. The aromatic ester repeating units may be about 100 mol. % or less, such as about 99.9 mol. % or less, such as about 99.5 mol. % or less, such as about 99 mol. % or less, such as about 98 mol. % or less, such as about 97 mol. % or less, such as about 95 mol. % or less of the polymer.

The aromatic dihydroxy repeating units present in the polymer may be derived from aromatic dihydroxy compounds. These may include, but are not limited to, hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl) ethane, etc., or a mixture thereof. They may also include alkyl, alkoxy, aryl and halogen substituents thereof, and combination thereof. In one particular embodiment, the aromatic dihydroxy compound may include hydroquinone, 4,4′-biphenol, or a mixture thereof. When employed, repeating units derived from aromatic dihydroxy compounds may constitute from about 1 mol. % or more, such as about 2 mol. % or more, such as about 3 mol. % or more, such as about 5 mol. % or more, such as about 8 mol. % or more, such as about 10 mol. % or more, such as about 15 mol. % or more, such as about 20 mol. % or more, such as about 25 mol. % or more, such as about 30 mol. % or more, such as about 35 mol. % or more, such as about 40 mol. % or more, such as about 45 mol. % or more of the polymer. They may constitute about 60 mol. % or less, such as about 50 mol. % or less, such as about 40 mol. % or less, such as about 30 mol. % or less, such as about 25 mol. % or less, such as about 20 mol. % or less, such as about 15 mol. % or less of the polymer.

The aromatic dicarboxylic repeating units in the polymer may be derived from aromatic dicarboxylic acids. These may include, but are not limited to, terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl) ether, bis(4-carboxyphenyl) butane, bis(4-carboxyphenyl) ethane, bis(3-carboxyphenyl) ether, bis(3-carboxyphenyl) ethane, etc., or a mixture thereof. They may also include alkyl, alkoxy, aryl and halogen substituents thereof, and combination thereof. In one particular embodiment, the aromatic dicarboxylic acid may include terephthalic acid, isophthalic acid, 2,6-naphthalenedicarboxylic acid, or a mixture thereof. When employed, repeating units derived from aromatic dicarboxylic acids may constitute about 5 mol % or more, such as about 10 mol. % or more, such as about 20 mol. % or more, such as about 30 mol. % or more, such as about 40 mol. % or more, such as about 50 mol. % or more, such as about 60 mol. % or more of the polymer. They may constitute 80 mol. % or less, such as about 70 mol. % or less, such as about 60 mol. % or less, such as about 50 mol. % or less, such as about 40 mol. % or less, such as about 30 mol. % or less, such as about 20 mol. % or less of the polymer.

The aromatic hydroxycarboxylic repeating units present in the polymer may be derived from aromatic hydroxycarboxylic acids. These may include, but are not limited to, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., or a mixture thereof. They may also include alkyl, alkoxy, aryl and halogen substituents thereof, and combination thereof. In one particular embodiment, the aromatic hydroxycarboxylic acid may include 4-hydroxybenzoic acid, 6-hydroxy-2-naphthoic acid, or a mixture thereof. When employed, repeating units derived from hydroxycarboxylic acids may constitute about 10 mol. % or more, such as about 20 mol. % or more, such as about 30 mol. % or more, such as about 40 mol. % or more, such as about 50 mol. % or more, such as about 60 mol. % or more, such as about 70 mol. % or more, such as about 80 mol. % or more of the polymer. They may constitute less than 100 mol. %, such as about 95 mol. % or less, such as about 90 mol. % or less, such as about 80 mol. % or less, such as about 70 mol. % or less, such as about 60 mol. % or less, such as about 50 mol. % or less, such as about 40 mol. % or less, such as about 30 mol. % or less of the polymer.

The aromatic amine repeating units present in the polymer may be derived from aromatic amines. These may include, but are not limited to, 4-aminophenol (“AP”), 3-aminophenol, 1,4-phenylenediamine, 1,3-phenylenediamine, etc. or a mixture thereof. Such aromatic amines may also include aromatic diamines. When employed, repeating units derived from aromatic amines may constitute from about 0.1 mol % or more, such as about 0.2 mol. % or more, such as about 0.5 mol. % or more, such as about 1 mol. % or more, such as about 2 mol. % or more, such as about 3 mol. % or more, such as about 5 mol. % or more, such as about 8 mol. % or more, such as about 10 mol. % or more, such as about 15 mol. % or more, such as about 20 mol. % or more, such as about 25 mol. % or more, such as about 30 mol. % or more, such as about 35 mol. % or more of the polymer. They may constitute about 40 mol. % or less, such as about 30 mol. % or less, such as about 25 mol. % or less, such as about 20 mol. % or less, such as about 15 mol. % or less, such as about 10 mol. % or less, such as about 8 mol. % or less, such as about 5 mol. % or less of the polymer.

In addition to the above, it should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Such repeating units may be present in an amount of about 20 mol. % or less, such as about 18 mol. % or less, such as about 15 mol. % or less, such as about 12 mol. % or less, such as about 10 mol. % or less, such as about 8 mol. % or less, such as about 6 mol. % or less, such as about 5 mol. % or less, such as about 4 mol. % or less, such as about 3 mol. % or less, such as about 2 mol. % or less, such as about 1 mol. % or less of the polymer. In other embodiments, the polymer may be “wholly aromatic” in that it lacks repeating units derived from non-aromatic (e.g., aliphatic or cycloaliphatic) monomers.

The polymer may have a relatively high melting temperature. For instance, the melting temperature may be about 250° C. or more, such as about 260° C. or more, such as about 270° C. or more, such as about 280° C. or more, such as about 290° C. or more, such as about 300° C. or more, such as about 310° C. or more, such as about 320° C. or more, such as about 330° C. or more, such as about 340° C. or more, such as about 350° C. or more. The melting temperature may be about 400° C. or less, such as about 380° C. or less, such as about 360° C. or less, such as about 350° C. or less, such as about 340° C. or less, such as about 320° C. or less, such as about 300° C. or less, such as about 280° C. or less. The melting temperature may be determined using means generally known in the art, such as differential scanning calorimetry.

Meanwhile, once the electrode assembly has been prepared, it may be provided into the interior cavity of the package. Referring again to FIGS. 1A-1C and 2A-2J, the figures illustrate the means in which the electrode assembly 72 may be connected to the package 50. For instance, to attach the electrode assembly 72 to the package 50, particularly in a mechanically stable manner, a first conductive member 60 and a second conductive member 62 are disposed within the interior cavity 58 of the package 50. In particular, the conductive members 60 and 62 may extend through the base 56 of the package 50 and into the interior cavity 58. In particular, the conductive members 60 and 62 may extend such that they terminate in a plane that is generally parallel to the base 56. In particular, such plane may refer to the lower (or outer) base surface 56b of the base 56 opposite the upper (or inner) base surface 56a adjacent the interior cavity 58.

The ultracapacitor and electrode assembly 72 likewise contain first and second leads 74 and 76, respectively, that extend outwardly from the electrode assembly 72 and are electrically connected to the first and second conductive members 60 and 62, respectively. Due to the perspective view, first and second leads 74 and 76 as well as first and second conductive members 60 and 62 are shown together. Although, it should be understood that each would be a separate element within the ultracapacitor. As indicated above, the conductive members may terminate along the outer base surface 56b of the base 56. In this regard, the conductive members 60 and 62 may simply extend through the base 56 and in such embodiment, they may form the external terminations 84 and 86 of the ultracapacitor for making an electrical connection, such as on a circuit board. Accordingly, in one embodiment, the first and second conductive members 60 and 62 may not be further connected to any other external terminations on the ultracapacitor or package 50.

Alternatively, a separate conductive trace (not shown) may be attached to the first conductive member 60 that extends through the base 56 and either forms the first external termination 84 or is connected to an additional conductive member that serves as the external termination 84. Similarly, the second conductive member 62 may extend through the base 56 to form the external termination 86, or a separate conductive trace (not shown) may be attached to the second conductive member 62 that extends through the base 56 and either forms the termination 86 or is connected to an additional conductive member that serves as the termination 86. When traces are employed, a via (not shown) may be formed within the base 56 to accommodate the trace.

As indicated, the first conductive member 60 and the second conductive member 62 are disposed within the interior cavity 58 of the package 50. In particular, the conductive members 60 and 62 may extend from and through the base 56 of the package 50 and into the interior cavity 58. The manner in which the respective conductive members is provided is not necessarily limited by the present disclosure. For instance, in one embodiment, the package 50 may be manufactured with openings in the base for providing the respective conductive member. In this regard, the respective conductive member may be inserted into such opening within the base 56 of the package 50. The respective conductive member may be affixed to the base 56 using means generally known in the art. For instance, such means would allow for the respective conductive member to remain affixed to the base while also preventing and/or minimizing any leakage into and from the package 50. For instance, the means may include an adhesive, such as a conductive adhesive.

In another embodiment, particularly wherein the package is formed from a polymer, such as a liquid crystalline polymer, the respective conductive members may be overmolded with the polymer. For instance, when forming the package from the polymer, the conductive members may be provided such that they are overmolded with the polymer. In general, such overmolding techniques are known in the art. Further, in one embodiment, an adhesive may also be applied to prevent and/or minimize any leakage into and from the package 50. In one embodiment, such adhesive may be a conductive adhesive as generally used in the art and industry. In one embodiment, such adhesive may be provided and contact the respective conductive members adjacent the outer surface 56b of the base 56.

The conductive members may be provided in any shape. In general, such shape may be elongated such that it extends into the interior cavity 58 of the package 50. The conductive members may have at least one dimension (e.g., width “W” or length “L”) of from about 0.05 mm or more, such as about 0.1 mm or more, such as about 0.2 mm or more, such as about 0.5 mm or more, such as 0.8 mm or more, such as about 1 mm or more, such as about 1.3 mm or more, such as about 1.5 mm or more to about 3 mm or less, such as about 2.8 mm or less, such as about 2.5 mm or less, such as about 2.3 mm or less, such as about 2 mm or less, such as about 1.8 mm or less, such as about 1.5 mm or less, such as about 1.3 mm or less, such as about 1 mm or less, such as about 0.5 mm or less, such as about 0.4 mm or less, such as about 0.2 mm or less, such as about 0.1 mm or less. The conductive members are typically formed from one or more layers of a metal, such as nickel, silver, gold, tin, copper, etc. If desired, the surface of the conductive members may be electroplated with nickel, silver, gold, tin, etc. as is known in the art. For instance, such electroplating may be beneficial in mounting the ultracapacitor to a circuit board.

As illustrated in FIGS. 1A, 1C, and 2A-2J, the conductive members 60 and 62 are positioned on the same end of the package 50 and base 56. In this regard, such configuration may be beneficial for accommodating an electrode assembly having terminals or leads on the same end of the electrode assembly. However, it should be understood that they may be positioned on opposing ends of the package 50 and base 56. Such a configuration may be beneficial for accommodating an electrode assembly having terminals or leads on opposing ends.

Furthermore, the electrode assembly 72 contains a first lead 74 that is electrically connected to a first electrode (not shown) and a second lead 76 that is electrically connected to a second electrode (not shown). The leads 74 and 76 extend outwardly from the electrode assembly 72 and are electrically connected to first and second conductive members 60 and 62, respectively.

As illustrated in FIGS. 2A-2J, the leads 74 and 76 extend from the same end of the electrode assembly 72. However, in another embodiment, it should be understood that the leads may extend from opposing ends of the electrode assembly. In addition, as illustrated, in one embodiment, the leads 74 and 76 may remain within the package 50 and may not extend beyond the interior cavity 58 of the package 50. In this regard, the leads 74 and 76 may not extend beyond the base 56, sidewalls 52, and lid 82 of the package 50.

In addition, in one embodiment, portions of the leads may remain extended from the electrode assembly in a manner such that the major surface of the electrode assembly may be generally parallel to the base 56. Of course, it should be understood that this is by no means required. In other embodiments, for example, the leads may be provided on a bottom surface or a top surface of the electrode assembly such that the leads and/or conductive members are configured in order to electrically contact one another.

In any event, attachment of the leads 74 and 76 to the conductive members 60 and 62 may generally be accomplished using any of a variety of known techniques. In certain embodiments, for example, welding techniques may be employed, such as ultrasonic welding, laser welding, resistance welding, etc. In yet other embodiments, a conductive adhesive may be employed to connect the conductive members to respective leads. In one particular embodiment, for example, the leads 74 and 76 are connected to the conductive members 60 and 62, respectively, with a conductive adhesive.

When employed, the conductive adhesive typically contains a plurality of particles that are formed from an electrically conductive material (e.g., metal). Examples of suitable conductive materials include, for instance, metals, such as nickel, copper, gold, silver, silver coated copper, silver coated nickel, etc., carbon materials, such as graphite, nickel coated carbon, etc.; and so forth. The conductive adhesive also generally contains a resinous material within which the conductive particles are dispersed. Although any resinous material may be employed, it is generally desired to use a resin that is a curable thermosetting resin, such as an epoxy resin, melamine resin, maleimide resin, polyimide resin, phenolic resin, etc. Epoxy resins are particularly suitable. Examples of suitable epoxy resins include, for instance, glycidyl ether type epoxy resins, such as bisphenol A type epoxy resins, bisphenol F type epoxy resins, phenol novolac type epoxy resins, orthocresol novolac type epoxy resins, brominated epoxy resins and biphenyl type epoxy resins, cyclic aliphatic epoxy resins, glycidyl ester type epoxy resins, glycidylamine type epoxy resins, cresol novolac type epoxy resins, naphthalene type epoxy resins, phenol aralkyl type epoxy resins, cyclopentadiene type epoxy resins, heterocyclic epoxy resins, etc. Still other suitable conductive adhesive resins may also be described in U.S. Patent Application Publication No. 2006/0038304 to Osako, et al. and U.S. Pat. No. 7,554,793 to Chacko. Typically, the resinous material constitutes from about 0.5 wt. % to about 50 wt. %, in some embodiments from about 1 wt. % to about 25 wt. %, and in some embodiments, from about 2 wt. % to about 20 wt. % of the dry weight of the adhesive. Likewise, the conductive particles typically constitute from about 50 wt. % to about 99.5 wt. %, in some embodiments from about 75 wt. % to about 99 wt. %, and in some embodiments, from about 80 wt. % to about 98 wt. % of the adhesive, on a dry basis. The adhesive may be applied using known techniques, such as screen-printing, dipping, electrophoretic coating, electron beam deposition, spraying, roller pressing, brushing, doctor blade casting, vacuum deposition, coating, etc. Regardless, once applied, the conductive adhesive may be cured as using any of a variety of known techniques, such as heat curing, actinic radiation curing (e.g., ultraviolet radiation, e-beam radiation, infrared radiation, etc.), and so forth.

The embodiments described above generally refer to the use of a single electrode assembly in the interior cavity of the package of the ultracapacitor. It should of course be understood, however, that the ultracapacitor of the present disclosure may also contain two or more electrode assemblies. For instance, in one such embodiment, for example, the ultracapacitor may include a stack of two or more electrode assemblies, which may be the same or different, within the interior cavity of the package of the ultracapacitor. Such assemblies may be electrically connected in series or parallel. Further, such assemblies may be provided in respective housings in one embodiment, each respective housing containing an electrolyte. Upon connecting the assemblies, the leads may be connected to the conductive members as disclosed herein.

### Properties and Applications

The ultracapacitor disclosed herein can exhibit desired properties for a variety of applications. For instance, the ultracapacitor may have a certain voltage allowing it to be used in various applications. The voltage may be 2 V or more, such as 2.2 V or more, such as 2.5 V or more, such as 2.7 V or more, such as 3 V or more. The ultracapacitor may have a voltage of 4 V or less, such as 3.5 V or less, such as 3.2 V or less, such as 3 V or less, such as 2.9 V or less. For instance, in one embodiment, the ultracapacitor may have a voltage of 2.7 V or 3.0 V. In one embodiment, the ultracapacitor may have a voltage of 2.7 V. In another embodiment, the ultracapacitor may have a voltage of 3.0 V.

Further, the ultracapacitor may exhibit excellent electrical properties, in particular when exposed to high temperatures. For example, the ultracapacitor may exhibit a capacitance of about 5 Farads per cubic centimeter (“F/cm³”) or more, such as about 6 F/cm³ or more, such as about 8 F/cm³ or more, such as about 9 F/cm³ or more, such as about 10 F/cm³ or more, such as about 13 F/cm³ or more, such as about 15 F/cm³ or more, such as about 20 F/cm³ or more. The capacitance may be 100 F/cm³ or less, such as about 90 F/cm³ or less, such as about 80 F/cm³ or less, such as about 70 F/cm³ or less, such as about 60 F/cm³ or less, such as about 50 F/cm³ or less, such as about 40 F/cm³ or less, such as about 30 F/cm³ or less, such as about 25 F/cm³ or less, such as about 20 F/cm³ or less, such as about 15 F/cm³ or less, such as about 10 F/cm³ or less. The capacitance may be measured at a voltage of 2.7V or 2.5V and a temperature of 65° C. or a voltage of 2.0 V and a temperature of 85° C.

The ultracapacitor may exhibit a capacitance of about 6 F or more, such as about 8 F or more, such as about 10 F or more, such as about 12 F or more, such as about 15 F or more, such as about 18 F or more. The capacitance may be 100 F or less, such as about 80 F or less, such as about 60 F or less, such as about 40 F or less, such as about 30 F or less, such as about 28 F or less, such as about 25 F or less, such as about 22 F or less, such as about 20 F or less, such as about 18 F or less, such as about 15 F or less, such as about 12 F or less.

The ultracapacitor may also have a low equivalence series resistance (“ESR”), such as about 500 mOhms or less, such as about 450 mOhms or less, such as about 400 mOhms or less, such as about 350 mOhms or less, such as about 300 mOhms or less, such as about 275 mOhms or less, such as about 250 mohms or less, such as about 230 mohms or less, such as about 200 mohms or less, such as about 180 mohms or less, such as about 150 mohms or less, such as about 130 mohms or less, such as about 100 mohms or less, such as about 90 mohms or less, such as about 80 mohms or less, such as about 70 mohms or less, such as about 60 mohms or less, such as about 50 mohms or less. The ESR may be 0.01 mohms or more, such as about 0.05 mohms or more, such as about 0.1 mohms or more, such as about 0.2 mohms or more, such as about 0.3 mohms or more, such as about 0.5 mohms or more, such as about 1 mohm or more, such as about 2 mohms or more, such as about 3 mohms or more, such as about 5 mohms or more, such as about 8 mohms or more, such as about 10 mohms or more, such as about 15 mohms or more, such as about 20 mohms or more, such as about 25 mohms or more, such as about 30 mohms or more, such as about 35 mohms or more, such as about 40 mohms or more, such as about 50 mohms or more, such as about 60 mohms or more, such as about 70 mohms or more, such as about 80 mohms or more, such as about 100 mohms or more, such as about 120 mohms or more, such as about 140 mohms or more, such as about 160 mohms or more, such as about 180 mohms or more, such as about 200 mohms or more. The ESR may be measured at a voltage of 2.7V or 2.5V and a temperature of 65° C. or a voltage of 2.0 V and a temperature of 85° C.

As indicated above, the resulting ultracapacitor may exhibit a wide variety of beneficial electrical properties, such as improved capacitance and ESR values. Notably, the ultracapacitor may exhibit excellent electrical properties even when exposed to high temperatures. For example, the ultracapacitor may be placed into contact with an atmosphere having a temperature of about 65° C., such as about 85° C. in some embodiments, in some embodiments from about 100° C. to about 150° C., and in other embodiments about 105° C. and demonstrate sustained performance. The capacitance and ESR values can remain stable at such temperatures for a substantial period of time, such as for about 100 hours or more, such as about 200 hours or more, such as about 300 hours or more, such as about 500 hours or more, such as about 800 hours or more, such as about 1000 hours or more, such as about 1200 hours or more, such as about 1500 hours or more, such as about 2000 hours or more, such as about 3000 hours or more, such as about 4000 hours or more, such as about 5000 hours or more. The time period may be 10000 hours or less, such as 8000 hours or less, such as 6000 hours or less, such as 5000 hours or less, such as 4000 hours or less, such as 3000 hours or less, such as 2000 hours or less, such as 1500 hours or less, such as 1300 hours or less, such as 1100 hours or less, such as 1000 hours or less, such as 800 hours or less, such as 600 hours or less, such as 400 hours or less.

For instance, after conditioning at 65° C. for one or more of the aforementioned time periods (e.g., 100, 200, 300, 500, 800, 1000, 1200, 1500, 2000, 3000, 4000, 5000 hours), the ultracapacitor may exhibit a capacitance within 40%, such as within 30%, such as within 20%, such as within 15%, such as within 10%, such as within 5% of the initial capacitance. Similarly, the ESR may be within 60%, such as within 50%, such as within 40%, such as within 30%, such as within 20%, such as within 10%, such as within 5% of the initial ESR. In one embodiment, the aforementioned percentages may also apply when conditioning at 85° C. for one or more of the aforementioned time periods.

Further, in one embodiment, the ratio of the capacitance value of the ultracapacitor after being exposed to the hot atmosphere (e.g., 65° C. or 85° C.) for one or more of the aforementioned time periods to the capacitance value of the ultracapacitor when initially exposed to the hot atmosphere is about 0.70 or more, such as about 0.75 or more, such as about 0.8 or more, such as about 0.85 or more, such as about 0.9 or more, such as about 0.95 or more. The ratio may be 1.0 or less, such as about 0.98 or less, such as about 0.95 or less, such as about 0.9 or less. Such high capacitance values can also be maintained under various extreme conditions, such as when applied with a voltage and/or in a humid atmosphere.

in one embodiment, the ratio of the capacitance value of the ultracapacitor after being exposed to the hot atmosphere (e.g., 85° C. or 105° C.) for 1008 hours to the capacitance value of the ultracapacitor when initially exposed to the hot atmosphere is about 0.75 or more, such as about 0.8 or more, such as about 0.85 or more, such as about 0.9 or more, such as about 0.95 or more. The ratio may be 1 or less, such as about 0.99 or less, such as about 0.98 or less, such as about 0.96 or less, such as about 0.94 or less, such as about 0.92 or less, such as about 0.9 or less, such as about 0.88 or less, such as about 0.86 or less, such as about 0.84 or less, such as about 0.82 or less.

Such high capacitance values can also be maintained under various extreme conditions, such as when applied with a voltage and/or in a humid atmosphere. For example, the ratio of the capacitance value of the ultracapacitor after being exposed to the hot atmosphere (e.g., 65° C., 85° C., or 105° C.) and an applied voltage to the initial capacitance value of the ultracapacitor when exposed to the hot atmosphere but prior to being applied with the voltage may be about 0.60 or more, such as about 0.65 or more, such as about 0.7 or more, such as about 0.75 or more, such as about 0.8 or more, such as about 0.85 or more, such as about 0.9 or more, such as about 0.95 or more. The ratio may be 1 or less, such as about 0.99 or less, such as about 0.98 or less, such as about 0.96 or less, such as about 0.94 or less, such as about 0.92 or less, such as about 0.9 or less, such as about 0.88 or less, such as about 0.86 or less, such as about 0.84 or less, such as about 0.82 or less. The voltage may, for instance, be about 1 volt or more, in some embodiments about 1.5 volts or more, and in some embodiments, from about 2 to about 10 volts (e.g., 2.1 volts). In one embodiment, for example, the ratio noted above may be maintained for 1008 hours or more.

The ultracapacitor may also maintain the capacitance values noted above when exposed to high humidity levels, such as when placed into contact with an atmosphere having a relative humidity of about 40% or more, in some embodiments about 45% or more, in some embodiments about 50% or more, and in some embodiments, about 70% or more (e.g., about 85% to 100%). Relative humidity may, for instance, be determined in accordance with ASTM E337-02, Method A (2007). For example, the ratio of the capacitance value of the ultracapacitor after being exposed to the hot atmosphere (e.g., 65° C., 85° C. or 105° C.) and high humidity (e.g., 85%) to the initial capacitance value of the ultracapacitor when exposed to the hot atmosphere but prior to being exposed to the high humidity may be about 0.7 or more, such as about 0.75 or more, such as about 0.8 or more, such as about 0.85 or more, such as about 0.9 or more, such as about 0.95 or more. The ratio may be 1 or less, such as about 0.99 or less, such as about 0.98 or less, such as about 0.96 or less, such as about 0.94 or less, such as about 0.92 or less, such as about 0.9 or less, such as about 0.88 or less, such as about 0.86 or less, such as about 0.84 or less, such as about 0.82 or less. In one embodiment, for example, this ratio may be maintained for 1008 hours or more.

The ESR can also remain stable at such temperatures for a substantial period of time, such as noted above. In one embodiment, for example, the ratio of the ESR of the ultracapacitor after being exposed to the hot atmosphere (e.g., 65° C., 85° C. or 105° C.) for one or more of the aforementioned time periods to the ESR of the ultracapacitor when initially exposed to the hot atmosphere is about 1.6 or less, such as about 1.5 or less, such as about 1.4 or less, such as about 1.3 or less, such as about 1.2 or less, such as about 1.1 or less, such as about 1.0 or less. The ratio may be about 0.2 or more, such as about 0.3 or more, such as about 0.4 or more, such as about 0.5 or more, such as about 0.6 or more, such as about 0.7 or more, such as about 0.8 or more, such as about 0.9 or more, such as about 1.0 or more. Notably, such low ESR values can also be maintained under various extreme conditions, such as when applied with a high voltage and/or in a humid atmosphere as described above.

Notably, such low ESR values can also be maintained under various extreme conditions, such as when applied with a high voltage and/or in a humid atmosphere as described above. For example, the ratio of the ESR of the ultracapacitor after being exposed to the hot atmosphere (e.g., 65° C., 85° C. or 105° C.) and an applied voltage to the initial ESR of the ultracapacitor when exposed to the hot atmosphere but prior to being applied with the voltage may be about 1.8 or less, such as about 1.7 or less, such as about 1.6 or less, such as about 1.5 or less, such as about 1.4 or less, such as about 1.3 or less, such as about 1.2 or less, such as about 1.1 or less, such as about 1 or less, such as about 0.9 or less, such as about 0.8 or less, such as about 0.7 or less, such as about 0.6 or less, such as about 0.5 or less. The ratio may be about 0.2 or more, such as about 0.3 or more, such as about 0.4 or more, such as about 0.5 or more, such as about 0.6 or more, such as about 0.7 or more, such as about 0.8 or more, such as about 0.9 or more, such as about 1 or more, such as about 1.1 or more, such as about 1.2 or more, such as about 1.3 or more, such as about 1.4 or more, such as about 1.5 or more. In one embodiment, for example, the ratio noted above may be maintained for 1008 hours or more.

The ultracapacitor may also maintain the ESR values noted above when exposed to high humidity levels. For example, the ratio of the ESR of the ultracapacitor after being exposed to the hot atmosphere (e.g., 65° C., 85° C. or 105° C.) and high humidity (e.g., 85%) to the initial capacitance value of the ultracapacitor when exposed to the hot atmosphere but prior to being exposed to the high humidity may be about 1.5 or less, such as about 1.4 or less, such as about 1.2 or less, such as about 1.1 or less, such as about 1 or less, such as about 0.9 or less, such as about 0.8 or less, such as about 0.7 or less, such as about 0.6 or less, such as about 0.5. The ratio may be about 0.2 or more, such as about 0.3 or more, such as about 0.4 or more, such as about 0.5 or more, such as about 0.6 or more, such as about 0.7 or more, such as about 0.8 or more, such as about 0.9 or more, such as about 1 or more, such as about 1.1 or more, such as about 1.2 or more, such as about 1.3 or more. In one embodiment, for example, this ratio may be maintained for 1008 hours or more.

The ultracapacitor may also have a relatively low leakage current. In general, “leakage current” is the amount of current which flows through the capacitor at a given DC voltage, for example at the rated DC voltage of the ultracapacitor. In this regard, when tested at 70° C. with an output current of 10 mA/F and charge voltage of 2.7V, the maximum leakage current may be 100 mA or less, such as 80 mA or less, such as 50 mA or less, such as 45 mA or less, such as 40 mA or less, such as 30 mA or less, such as 20 mA or less, such as 10 mA or less.

Furthermore, the ultracapacitor as disclosed herein may be utilized in a variety of manners for a variety of applications. In one embodiment, the ultracapacitor may be mounted onto a circuit board, such as a printed circuit board. In this regard, the present disclosure may also be directed to a circuit board comprising an ultracapacitor as defined herein. In general, the circuit board contains a substrate (e.g., insulating layer) having an upper surface and a lower surface as well as a plurality of electrical current paths defined therein. The conductive members of the ultracapacitor may be in respective electrical communication with the predetermined current paths of the circuit board. In addition, the conductive members of the ultracapacitor can be physically connected to the circuit board using any method generally known in the art, such as general soldering techniques.

The ultracapacitor and circuit board as disclosed herein may be employed in many applications. As one example, these applications can include various communications devices. For instance, they can include Ethernet systems, wireless network routers, fiber optic communications systems, storage devices, mobile devices, computer memory devices (e.g., RAM), etc.

### Test Methods

Equivalent Series Resistance (ESR): Equivalence series resistance may be measured using a Hiller Instrument by the IEC-62391 (2022) method. The operating frequency is 1 kHz. A variety of temperature and relative humidity levels may be tested. For example, the temperature may be 23° C., 85° C. or 105° C., and the relative humidity may be 25% or 85%.

Capacitance: The capacitance may be measured using a Hiller Instrument by the IEC-62391 (2022) method. A variety of temperature and relative humidity levels may be tested. For example, the temperature may be 23° C., 85° C. or 105° C., and the relative humidity may be 25% or 85%.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the disclosure so further described in such appended claims.

What is claimed is:

1. An ultracapacitor comprising:
a package comprising
a base having an inner base surface and an outer base surface opposite the inner base surface,
sidewalls extending in a direction generally perpendicular to the base and defining a first upper end and a first sidewall inner surface,
an interior cavity defined between the inner base surface and the first sidewall inner surface, and
a lid enclosing the interior cavity,
wherein the base and the sidewalls are formed from a liquid crystalline polymer,
a first conductive member and a second conductive member disposed in the interior cavity and extending from the base;
an electrode assembly positioned within the interior cavity of the package, the electrode assembly comprising a first electrode and a second electrode electrically connected to a first lead and a second lead, respectively, extending from the electrode assembly, wherein the first lead and the second lead are electrically connected to the first conductive member and the second conductive member, respectively; and
an electrolyte within the interior cavity of the package.

2. The ultracapacitor of claim 1, wherein the lid contacts the first upper end and the first sidewall inner surface.

3. The ultracapacitor of claim 1, wherein the sidewalls further define a second upper end and a second sidewall inner surface, the first upper end and the first sidewall inner surface positioned closer to the interior cavity than the second upper end and the second sidewall inner surface, respectively.

4. The ultracapacitor of claim 1, wherein the lid contacts the first upper end, the first sidewall inner surface, and the second sidewall inner surface.

5. The ultracapacitor of claim 1, wherein the lid comprises a lid cavity adjacent to the interior cavity.

6. The ultracapacitor of claim 1, wherein the sidewalls and the base are integrally formed.

7. The ultracapacitor of claim 1, wherein the first conductive member and the second conductive member extend through the base to a plane generally parallel to the outer base surface.

8. The ultracapacitor of claim 1, wherein the liquid crystalline polymer comprises a liquid crystalline polyester.

9. The ultracapacitor of claim 1, wherein the liquid crystalline polymer is formed from one or more aromatic dihydroxy compounds, one or more aromatic dicarboxylic acids, one or more aromatic hydroxycarboxylic acids, or a mixture thereof.

10. The ultracapacitor of claim 1, wherein the liquid crystalline polymer is formed from at least two of one or more aromatic dihydroxy compounds, one or more aromatic dicarboxylic acids, and one or more aromatic hydroxycarboxylic acids.

11. The ultracapacitor of claim 1, wherein the liquid crystalline polymer has a melting temperature of about 250° C. or more to about 400° C. or less as determined using differential scanning calorimetry.

12. The ultracapacitor of claim 1, wherein the electrode assembly contains a first electrode that comprises a first current collector electrically coupled to a first carbonaceous coating, a second electrode that comprises a second current collector electrically coupled to a second carbonaceous coating wherein the first current collector and the second current collector each contain a substrate that includes a conductive metal, and a separator positioned between the first electrode and the second electrode.

13. The ultracapacitor of claim 12, wherein the conductive metal is aluminum or an alloy thereof and/or wherein a plurality of fiber-like whiskers projects outwardly from the substrate of the first current collector, the substrate of the second current collector, or both.

14. The ultracapacitor of claim 12, wherein the carbonaceous coating of the first electrode, the second electrode, or a combination thereof contains activated carbon particles and (a) wherein at least 50% by volume of the activated carbon particles have a size of from about 0.01 to about 30 micrometers and/or (b) wherein the activated carbon particles contain a plurality of pores, wherein the amount of pores having a size of about 2 nanometers or less is about 50 vol. % or less of the total pore volume, the amount of pores having a size of from about 2 nanometers to about 50 nanometers is about 20 vol. % to about 80 vol. % of the total pore volume, and the amount of pores having a size of about 50 nanometers or more is from about 1 vol. % to about 50 vol. % of the total pore volume.

15. The ultracapacitor of claim 1, wherein the electrolyte includes a nonaqueous solvent and an ionic liquid.

16. The ultracapacitor of claim 15, wherein the nonaqueous solvent includes a first sulfur-containing compound comprising sulfolane or derivative thereof and a second sulfur-containing compound comprising a sulfone.

17. The ultracapacitor of claim 16, wherein the electrolyte further comprises a lithium metal salt.

18. The ultracapacitor of claim 16, wherein the electrolyte has a melting point of from −50° C. to 100° C.

19. A circuit board including the ultracapacitor of claim 1.

20. A communications device including the ultracapacitor of claim 1.

21. An ultracapacitor comprising:
a package comprising
a base having an inner base surface and an outer base surface opposite the inner base surface,
sidewalls extending in a direction generally perpendicular to the base and defining a first upper end, a second upper end, a first sidewall inner surface, and a second sidewall inner surface,
an interior cavity defined between the inner base surface and the first sidewall inner surface, wherein the first upper end and the first sidewall inner surface are positioned closer to the interior cavity than the second upper end and the second sidewall inner surface, and
a lid enclosing the interior cavity and contacting the first upper end, the first sidewall inner surface, and the second sidewall inner surface,
a first conductive member and a second conductive member disposed in the interior cavity and extending from the base;
an electrode assembly positioned within the interior cavity of the package, the electrode assembly comprising a first electrode and a second electrode electrically connected to a first lead and a second lead, respectively, extending from the electrode assembly, wherein the first lead and the second lead are electrically connected to the first conductive member and the second conductive member, respectively; and
an electrolyte within the interior cavity of the package.
